(19) United States
(12) Patent Application Publication
(10) Pub. No.: US 2009/0109325 A1
(43) Pub. Date: Apr. 30, 2009

(54) PORTABLE DEVICE AND IMAGE PICKUP DEVICE

(75) Inventors: Ryo IMAI, Kurokawa-gun (JP); Kazuhisa Horikiri, Minato-ku (JP); Masayuki Sakai, Minato-ku (JP); Noriko Katayama, Minato-ku (JP); Atsushi Misawa, Kurokawa-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/261,526

(22) Filed: Oct. 30, 2008

(30) Foreign Application Priority Data
Oct. 31, 2007 (JP) 2007-284077

(51) Int. Cl. H04N 5/225; G03B 17/00

(52) U.S. Cl. 348/373; 396/448; 348/E05.024

(57) ABSTRACT

A portable device having a first enclosure and a second enclosure, comprises: a linking device which slidably links the first enclosure and second enclosure in a slidable manner, the linking device permitting a first action of shifting the first enclosure between a first position and a second position in a plane, and a second action of shifting the first enclosure at least in a direction different from a direction of the first action in the plane using at least one of the first position and second position as a reference position; and a command input device which inputs a command to the portable device on the basis of at least the second action of the first enclosure, thereby enabling to operate the portable device according to the action of the first enclosure.

### BACKGROUND OF THE INVENTION

1. Field of the Invention

The present invention relates to a portable device and an image pickup device, and more particularly to a portable device and an image pickup device which are operable in a plurality of directions.

2. Description of the Related Art

A camera provided with a lens barrier which covers the front face of the lens when the camera is not in use and exposes the front face of the lens to make the lens usable when the camera is to be used. This lens barrier in many cases performs not only the role of protecting the lens but also that of a switch which turns on and off power supply to the camera. As a case of adding another function to this lens barrier, Japanese Patent Application Laid-Open No. 2007-33996 discloses a camera whose lens protecting member, which is a lens barrier, is made movable to a plurality of positions, and in which the operation unit is assigned different functions according to these positions. This technique enables a single operation unit to be assigned a plurality of functions according to the position of the lens barrier, and thereby to restrain the increase in the number of required constituent parts.

Japanese Patent Application Laid-Open No. 2002-90863 discloses a camera in which a main front part of a lens barrier is detachable as an external barrier member, the external barrier member functioning as a remote controller for the camera per se. This configuration enables the barrier to protect the lens when the camera is not in use and to serve as a remote controller when the camera is to be used. In addition, accidental loss of the remote controller during the carriage of the camera can also be prevented by this configuration.

### SUMMARY OF THE INVENTION

As the essential purpose of the lens barrier is to protect the lens when the camera is not in use, it is desirable for the lens barrier to stop in one of its lens protecting position and its position to expose the lens to make the lens available for use. Such a configuration enables the lens, after the camera has been used, to be protected only by reversing the position of the lens barrier.

However, the configuration disclosed in Japanese Patent Application Laid-Open No. 2007-33996 which enables the lens barrier to be moved among a plurality of positions makes it necessary to check by the user's own eyes in what position the lens barrier has stopped. Moreover, the assignment of plurality of functions to a single operation unit, though contributing to reducing the number of required constituent parts, involves another problem that it is difficult and troublesome for the user to perceive and remember functions assigned to positions of the lens barrier.

The camera according to Japanese Patent Application Laid-Open No. 2002-90863, as the main front part of its lens barrier is detachable as an external barrier member, has a drawback that the external barrier member may come off and become unable to properly protect the lens when the camera is not in use.

An object of the present invention, attempted in view of these problems, is to provide a portable device which is capable of protecting the lens and other parts when the camera is not in use and executing various operations including camera operations by moving an enclosure such as a lens barrier.

According to a first aspect of the present invention, a portable device having a first enclosure and a second enclosure, includes: a linking device which slidably links the first enclosure and second enclosure in a slidable manner, the linking device permitting a first action of shifting the first enclosure between a first position and a second position in a plane, and a second action of shifting the first enclosure at least in a direction different from a direction of the first action in the plane using at least one of the first position and second position as a reference position; and a command input device which inputs a command to the portable device on the basis of at least the second action of the first enclosure.

The portable device according to the first aspect of the present invention has the first enclosure and the second enclosure which are slidably linked. The linking device permits the first action of shifting the first enclosure between the first position and the second position in the same plane, and the second action of shifting the first enclosure at least in a direction different from the first action in the same plane with at least one of the first position and the second position as the reference position. Commands to the portable device are inputted on the basis of at least the second action of the first enclosure. In this way, by moving enclosures, the portable device can be driven in various operating modes or operated in many different ways without manipulation of a button or the like. In addition, by adding shifts in the first position or the second position as well as shifts between the first position and the second position, various operations are made possible by moving the enclosures. Furthermore, the required number of buttons and such items can be reduced because no manipulation of a button or the like is needed.

According to a second aspect of the present invention, in the portable device according to the first aspect, the linking device so links the first enclosure and second enclosure as to enable the first enclosure to automatically return to the reference position after the second action.

In the portable device according to the second aspect, the first enclosure and the second enclosure are so linked as to enable the first enclosure to automatically return to the reference position after the second action. This arrangement contributes to enhancing operability of the device.

According to a third aspect of the present invention, in the portable device according to the first or second aspect, the linking device links the first enclosure and second enclosure so as to be movable, as the second action, in a direction identical to that of the first action.

In the portable device according to the third aspect, the first enclosure and the second enclosure are linked so as to be movable, as the second action, in a direction identical to that of the first action, as well as in a direction different from that of the first action, and so as to allow the first enclosure to automatically return to the reference position after the shift. This arrangement makes available various manipulations as the second action.

According to a fourth aspect of the present invention, in the portable device according to any of the first through third aspects, the linking device so links the first enclosure and second enclosure as to enable to move in four, eight or all directions as the second action.

In the portable device according to the fourth aspect, the first enclosure can be moved in four, eight or all directions in the second action. This feature makes the device adaptable to many different manipulations.

According to a fifth aspect of the present invention, in the portable device according to any of the first through fourth aspects, the linking device includes: a unit which links the first enclosure and the second enclosure in a manner permitting the first action; and a unit which connects the first enclosure and the second enclosure in a manner permitting the second action.

In the portable device according to the fifth aspect, the first enclosure and the second enclosure are linked by a unit which links in a manner that permitting the first action and a unit which links in a manner permitting the second action. This arrangement makes the device adaptable to various configurations.

According to a sixth aspect of the present invention, in the portable device according to any of the first through fifth aspects, the linking device comprises a unit which holds the first enclosure and the second enclosure in the first position and the second position with a prescribed holding force.

In the portable device according to the sixth aspect, the first enclosure and the second enclosure are halted with a prescribed holding force in the first position and the second position. This feature can prevent the enclosures from moving inadvertently and from consequent unintended operation.

According to a seventh aspect of the present invention, in the portable device according to any of the first through sixth aspects, the linking device so links the first enclosure and second enclosure as to enable to the second action with a force smaller than the holding force.

In the portable device according to the seventh aspect, the first enclosure can accomplish the second action with a force smaller than the holding force. This feature can prevent the enclosures from moving inadvertently and from consequent unintended operation.

According to an eighth aspect of the present invention, the portable device according to any of the first through seventh aspects further includes a second action detecting device which detects a direction of the second action, and the command input device inputs to the portable device a command corresponding to the direction of the second action detected by the second action detecting device.

In the portable device according to the eighth aspect, a command corresponding to the direction of the second action is inputted to the portable device. This enables the portable device to be operated by having the first enclosure take the second action.

According to a ninth aspect of the present invention, the portable device according to the eighth aspect further includes a first action detecting device which, when the first action has been taken, detects whether the first enclosure is in the first position or the second position, and the command input device differentiates between a command corresponding to the direction of the second action when the first enclosure detected by the first action detecting device is in the first position and that when the first enclosure is in the second position.

In the portable device according to the ninth aspect, whether the first enclosure is in the first position or the second position is detected, and the command corresponding to the direction of the second action differs between when the first enclosure is in the first position and when it is in the second position. By varying the control between the first position and the second position in addition to detecting shifts between the first position and the second position, the device is made adaptable to many different operating modes and manipulations.

According to a tenth aspect of the present invention, the portable device according to the eighth aspect further includes a first action detecting device which, when the first action has been taken, detects whether the first enclosure is in the first position or the second position, and the command input device turns on power supply to the portable device when the first detecting device detects that the first enclosure is in the second position.

In the portable device according to the tenth aspect, when it is detected that the first enclosure is in the second position, power supply to the portable device is turned on. This arrangement serves to interlock the manipulation of enclosures with the turning-on of power supply, thereby contributing to enhancing the operability.

According to an eleventh aspect of the present invention, an image pickup device includes: the portable device according to any of the first through tenth aspects, and a shooting lens arranged in front of the second enclosure is covered with the first enclosure when in the first position and the shooting lens is exposed when in the second position.

In the image pickup device according to the eleventh aspect, the shooting lens is arranged in front of the second enclosure. When the first enclosure and the second enclosure are in the first position, the shooting lens is covered with the first enclosure. In addition, when the first enclosure and the second enclosure are in the second position, the shooting lens is exposed in front. This arrangement serves to protect the shooting lens when the image pickup device is not in use, and exposes the front face of the lens to make the lens usable for shooting when the image pickup device is used.

According to a twelfth aspect of the present invention, in the image pickup device according to the eleventh aspect, the first enclosure is a lens barrier.

According to the present invention, it is made possible not only to protect the lens and other parts when the camera is not in use but also to execute various operations including camera operations by moving an enclosure such as a lens barrier.

### BRIEF DESCRIPTION OF THE DRAWINGS

FIGS. 1A to 1C show external views of a digital camera 1 according to a first preferred embodiment of the present invention, when silhouettes of a first enclosure 10, a second enclosure 20 and a third enclosure 30 thereof overlap one another at a first position, wherein FIG. 1A is a front view, FIG. 1B is a profile and FIG. 1C is a rear view;

FIGS. 2A to 2C show external views of the digital camera 1 when the first enclosure 10, the second enclosure 20 and the third enclosure 30 have been moved in parallel from the first position to a second position, wherein FIG. 1A is a front view, FIG. 1B is a profile and FIG. 1C is a rear view;

FIG. 3 shows an exploded perspective view of essential parts of the digital camera 1;

FIG. 4 illustrates a linking mechanism of the digital camera 1;

FIG. 5 also illustrates the linking mechanism of the digital camera 1;

FIGS. 6A to 6C also show external views of the digital camera 1 when the first enclosure 10, the second enclosure 20 and the third enclosure 30 have been moved in parallel from the first position to the second position, wherein FIG. 6A is a front view, FIG. 6B is a profile and FIG. 6C is a rear view;

FIGS. 7A and 7B illustrate the fitting between the first enclosure 10 and the third enclosure 30 of the digital camera 1, wherein FIG. 7A is a sectional view and FIG. 7B is a perspective view;

FIGS. 8A and 8B are sectional views illustrating the fitting between the first enclosure 10 and the third enclosure 30 of the digital camera 1;

FIG. 9 is a block diagram showing the electrical configuration of the digital camera 1;

FIG. 10 is a flow chart showing the stream of processing in the digital camera 1;

FIG. 11 is another flow chart showing the stream of processing in the digital camera 1;

FIG. 12 is another flow chart showing the stream of processing in the digital camera 1;

FIGS. 13A to 1C show external views of the digital camera 1 when the first enclosure 10, the second enclosure 20 and the third enclosure 30 have been moved in parallel from the first position to the second position, wherein FIG. 13A is a front view, FIG. 13B is a profile and FIG. 13C is a rear view;

FIG. 14 shows a perspective view illustrating the fitting between the first enclosure 10 and the third enclosure 30 of a digital camera 1a according to a modified version of the first embodiment of the present invention;

FIG. 15 is a sectional view illustrating the fitting between the first enclosure 10′ and the third enclosure 30′ of the digital camera 1a;

FIGS. 16A and 16B illustrate the operation of a digital camera 1b according to another modified version of the first embodiment of the present invention;

FIGS. 17A to 17C show external views of a digital camera 1c according to another modified version of the first embodiment of the present invention, when the first enclosure 10, the second enclosure 20 and the third enclosure 30 have been moved in parallel from the first position to the second position, wherein FIG. 17A is a front view, FIG. 17B is a profile and FIG. 17C is a rear view;

FIG. 18 illustrates the operation of a digital camera 1d according to another modified version of the first embodiment of the present invention;

FIGS. 19A to 19C show external views of the digital camera according to this other modified version of the first embodiment of the present invention, when the first enclosure 10, the second enclosure 20 and the third enclosure 30 have been moved in parallel from the first position to the second position, wherein FIG. 19A is a front view, FIG. 19B is a profile and FIG. 19C is a rear view;

FIG. 20 is a block diagram showing the electrical configuration of a digital camera 1e according to another modified version of the first embodiment of the present invention;

FIG. 21 is a flow chart showing the stream of processing in the digital camera 1e;

FIG. 22 shows an external view of a mobile telephone 2 according to the first embodiment of the present invention, when silhouettes of a first enclosure 50, a second enclosure 60 and a third enclosure 70 thereof overlap one another in a first position;

FIG. 23 shows an external view of the mobile telephone 2 when the first enclosure 50, the second enclosure 60 and the third enclosure 70 have been moved in parallel from the first position to a second position;

FIG. 24 shows an exploded perspective view of essential parts of the mobile telephone 2;

FIG. 25 illustrates the linking mechanism of the mobile telephone 2;

FIG. 26 also illustrates the linking mechanism of the mobile telephone 2;

FIG. 27 also illustrates the linking mechanism of the mobile telephone 2;

FIG. 28 illustrates the operation of the mobile telephone 2;

FIG. 29 is a block diagram showing the electrical configuration of the mobile telephone 2;

FIG. 30 is a flow chart showing the stream of processing in the mobile telephone 2;

FIG. 31 is another flow chart showing the stream of processing in the mobile telephone 2;

FIG. 32 is another flow chart showing the stream of processing in the mobile telephone 2;

FIG. 33 is another flow chart showing the stream of processing in the mobile telephone 2;

FIG. 34 is another flow chart showing the stream of processing in the mobile telephone 2; and

FIG. 35 is another flow chart showing the stream of processing in the mobile telephone 2.

### DETAILED DESCRIPTION OF THE PREFERRED EMBODIMENTS

Preferred embodiments of the present invention to realize a portable device will be described in detail below with reference to the accompanying drawings.

### First Preferred Embodiment

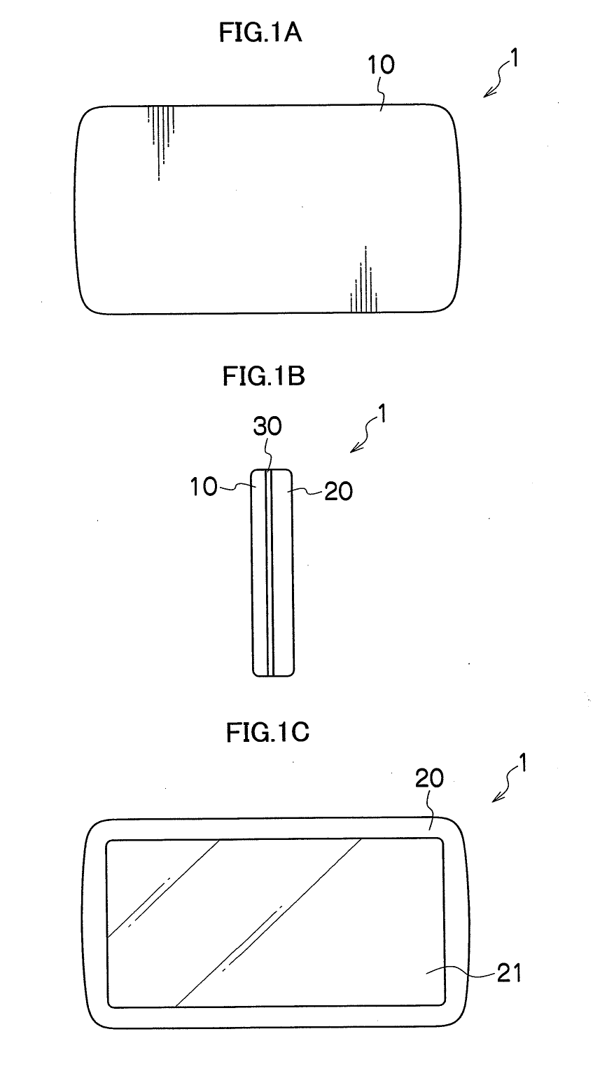

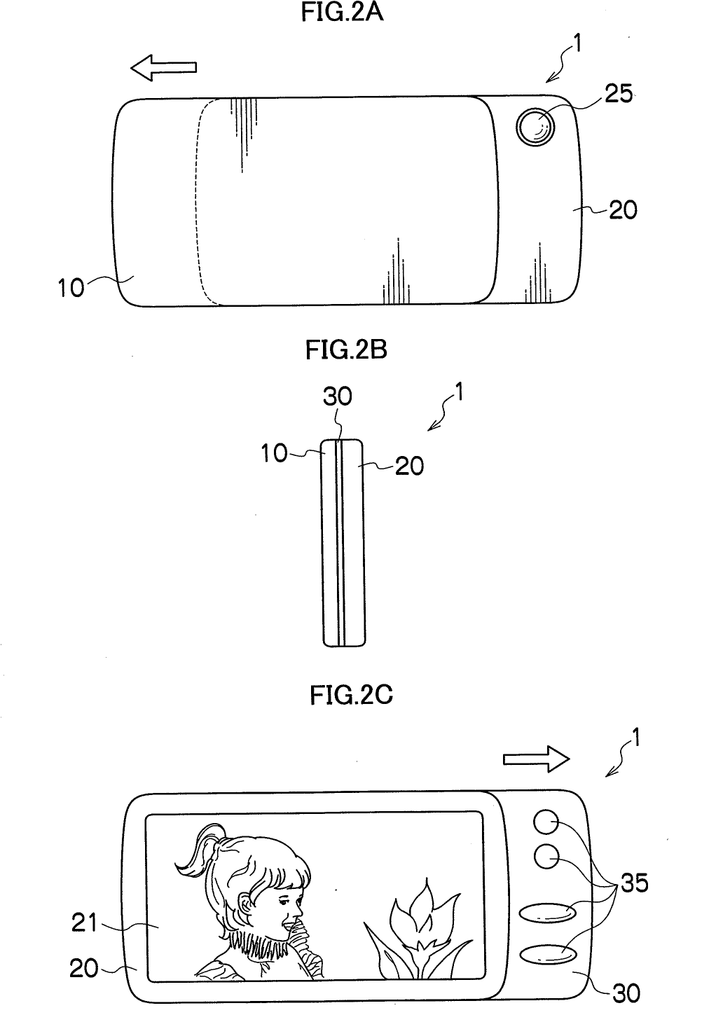

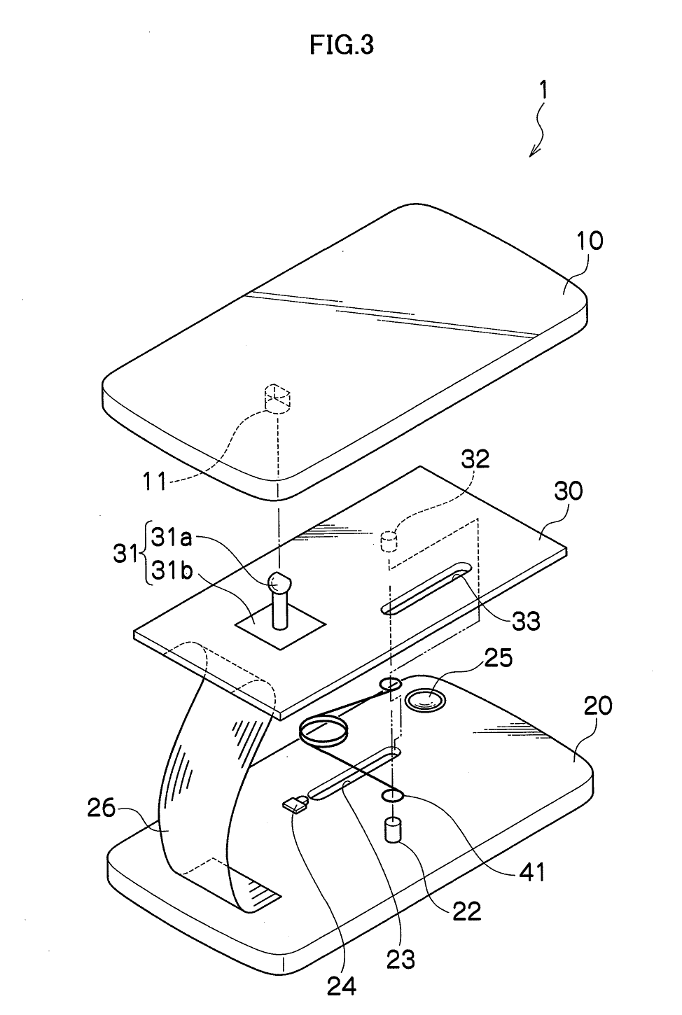

FIGS. 1A to 1C and FIGS. 2A to 2C show external views of a digital camera 1, according to a first preferred embodiment of the present invention, in which FIGS. 1A and 2A are front views, FIGS. 1B and 2B are profiles, and FIGS. 1C and 2C are rear views. FIGS. 1A to 1C show a case where silhouettes of a first enclosure 10, a second enclosure 20 and a third enclosure 30 are overlapping one another in a first position, while FIGS. 2A to 2C show a case where the first enclosure 10, the second enclosure 20 and the third enclosure 30 have been moved in parallel from the first position to a second position. FIG. 3 shows an exploded perspective view of essential parts of the digital camera 1.

The digital camera 1 includes the first enclosure 10, the second enclosure 20 and the third enclosure 30. As shown in FIGS. 1A to 1C, the first position is a state in which the shooting lens and the operation unit are stored instead of being exposed. As shown in FIGS. 2, the second position is a state in which the camera is ready to shoot, with a shooting lens assembly 25 arranged on the front side of the second enclosure 20 and an operation unit 35 arranged on the front side of the third enclosure 30 being exposed.

### [Structure of Digital Camera 1]

The first enclosure 10, which is a substantially rectangular planar member, is used as a lens barrier. On the rear side of the first enclosure 10, a fitting part 11 (of which details will be described afterwards) to which a stick switch 31 stuck to the third enclosure 30 is to be fitted is arranged. By fitting the stick switch 31 to the first enclosure 10 via the fitting part 11, the first enclosure 10 and the third enclosure 30 are assembled integrally.

On the rear face of the second enclosure 20, which is a substantially cuboidal member of approximately the same size as the first enclosure 10, mainly a monitor 21 is arranged as shown in FIGS. 1C and 2C. On the front face of the second enclosure 20, a boss 22, a long hole 23, a push switch 24, the shooting lens 25, a flexible printed circuit board 26 and so forth are mainly arranged as shown in FIG. 3.

On the front face of the third enclosure 30, which is a substantially rectangular planar member smaller than the first enclosure 10 and the second enclosure 20, the stick switch 31 is mainly arranged, and on its rear face a boss 32 and a long hole 33 are arranged as shown in FIG. 3.

The monitor 21 is, for example, configured of a liquid crystal display capable of displaying in color. This monitor 21 is used not only as a image display panel for displaying a shot image in the reproduction mode but also as a user interface display panel when various setting operations are done. Further, when in the shooting mode, an image through the lens (pass-trough image) is displayed as required for use as an electronic viewfinder for shooting angle confirmation.

The push switch 24 is a switch which is turned on when its tip is pressed and turned off when the same is released.

The shooting lens 25 includes a bendable zoom lens.

One end of the flexible printed circuit board 26 is connected to a substrate or the like (not shown) arranged within the second enclosure 20, and the other end, to a substrate or the like (not shown) arranged within the third enclosure 30.

The stick switch 31 includes a stick 31a whose tip is formed in a substantially spherical shape and a switch part 31b which detects the motions of the stick 31a as shown in FIG. 3. The stick 31a can be levered in a total of eight directions including cross directions and obliquely cross directions. Further, the switch part 31b can detect any fall of the stick 31a and the direction of the fall. The stick switch 31 is so configured that the stick 31a is placed at normal times in its reference position, namely in a position in which the stick 31a is upright from the switch part 31b. The stick 31a is inclined by lever operation by about 10 degrees to 15 degrees in each direction and stopped there. The configuration is such that, once external forces are eliminated after the lever operation, the stick 31a automatically returns to its reference position.

### ((On Mechanism Regarding Shifts Between First Position and Second Position))

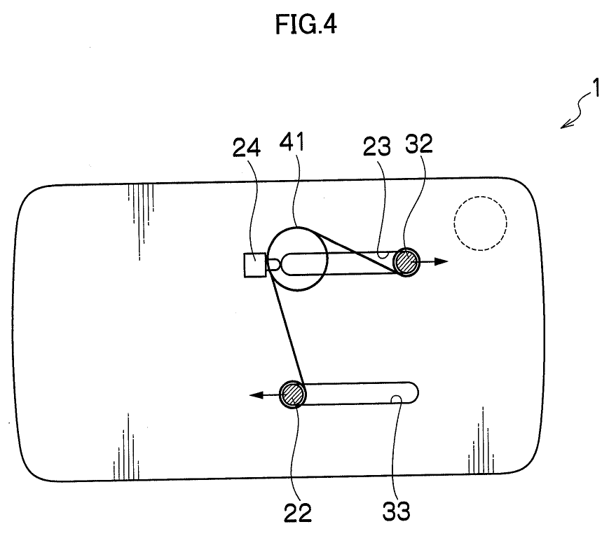

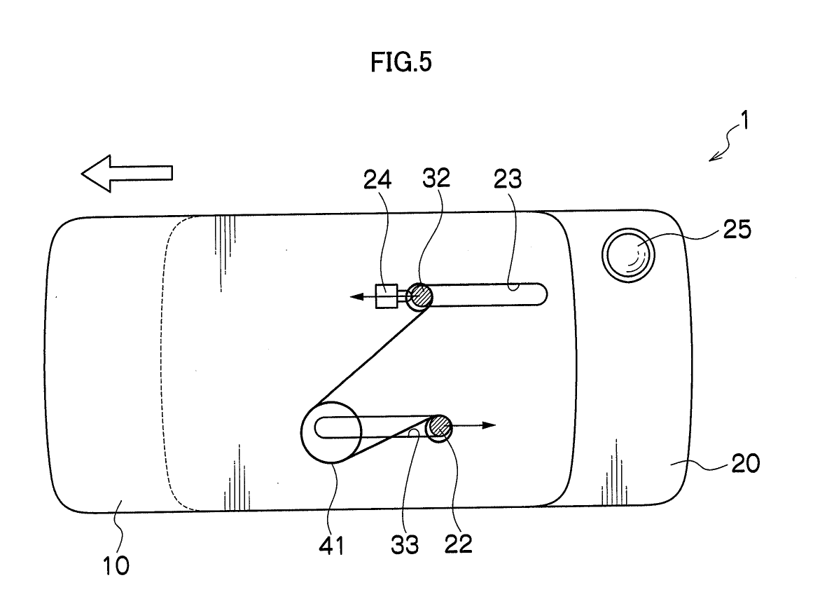

A linking mechanism of movably linking the first enclosure 10, the third enclosure 30 and the second enclosure 20 will be described. FIG. 4 shows a view of the linking mechanism when the first enclosure 10, the second enclosure 20 and the third enclosure 30 are in a first position as seen through from the front face side of the first enclosure 10, while FIG. 5 shows a view of the linking mechanism when the first enclosure 10, the second enclosure 20 and the third enclosure 30 are in a second position as seen through from the front face side of the first enclosure 10.

First, the configuration of the linking mechanism will be described. The linking mechanism comprises the boss 22, the long hole 23 and the push switch 24 arranged in the second enclosure 20, the boss 32 and the long hole 33 arranged in the third enclosure, and a spring 41 as shown in FIG. 3.

Two ends of the spring 41 are rotatably inserted into the bosses 22 and 32, and the boss 22 can slide within the long hole 33 while the boss 32 can slide within the long hole 23.

The bores of the long holes 23 and 33 are greater than the diameters of the bosses 32 and 22, respectively, to enable the bosses 32 and 22 to fit into the holes.

The push switch 24 is arranged at the left end of the long hole 33, and contact of the boss 32 with the switch makes it possible to detect in which of the first and second positions the first enclosure 10, the second enclosure 20 and the third enclosure 30 are located.

The spring 41 is a coil spring which applies a force in the rewinding direction, and its two ends are shaped round. One end of the spring 41 is rotatably inserted into the boss 22 while the other end is rotatably inserted into the boss 32.

After the two ends of the spring 41 are inserted into the boss 22 and the boss 32, the boss 22 is inserted into the long hole 33 and the boss 32 is inserted into the long hole 23. After that, a pin, screw or the like (not shown) is fitted to the tip of the boss 22 to prevent the boss 22 from coming off the long hole 33, and a pin, screw or the like (not shown) is fitted to the tip of the boss 32 to prevent the boss 32 from coming off the long hole 23. This procedure results in linkage of the first enclosure 10 and the third enclosure 30 with the second enclosure 20 allowing movement between them.

Next, the method of shifting the first enclosure 10, the second enclosure 20 and the third enclosure 30 between their first position and second position will be described.

In the first position, as shown in FIG. 4, the boss 22 is placed at the left end of the long hole 33, and the boss 32 is placed at the right end of the long hole 23. The spring 41 applies a rightward force, as viewed from the front, to the first enclosure 10 and the third enclosure 30. However, as the boss 22 is placed at the left end of the long hole 33, the first enclosure 10 and the third enclosure 30 cannot be shifted rightward. In this way, the first enclosure 10 and the third enclosure 30 are held in the first position.

In the first position, when the first enclosure 10 and the third enclosure 30 are shifted leftward against the rightward force of the spring 41, the boss 22 slides leftward within the long hole 33 and the boss 32 slides leftward within the long hole 23. This causes the first enclosure 10 and the third enclosure 30 to shift parallel leftward over the surface of the second enclosure 20 and the first enclosure 10, the second enclosure 20 and the third enclosure 30 to shift from the first position to the second position.

In the second position, as shown in FIG. 5, the boss 22 is placed at the right end of the long hole 33 and the boss 32 is placed at the left end of the long hole 23. The spring 41 applies a leftward force, as viewed from the front, to the first enclosure 10 and the third enclosure 30. However, as the boss 22 is placed at the right end of the long hole 33, the first enclosure 10 and the third enclosure 30 cannot be shifted leftward. In this way, the first enclosure 10 and the third enclosure 30 are held in the second position.

Further in the second position, as the boss 32 turns on the push switch 24, the placement of the first enclosure 10, the second enclosure 20 and the third enclosure 30 in the second position is detected.

In the second position, when the first enclosure 10 and the third enclosure 30 are shifted rightward against the leftward force of the spring 41, the boss 22 slides rightward within the long hole 33 and the boss 32 slides rightward within the long hole 23. This causes the first enclosure 10 and the third enclosure 30 to shift parallel rightward over the surface of the second enclosure 20 and the first enclosure 10, the second enclosure 20 and the third enclosure 30 to return from the second position to the first position.

In this way, the shooting lens is protected when the camera is not in use and shooting is made possible by exposing the shooting lens when the camera is to be used.

### ((On Mechanism Regarding Operation of First Enclosure 10))

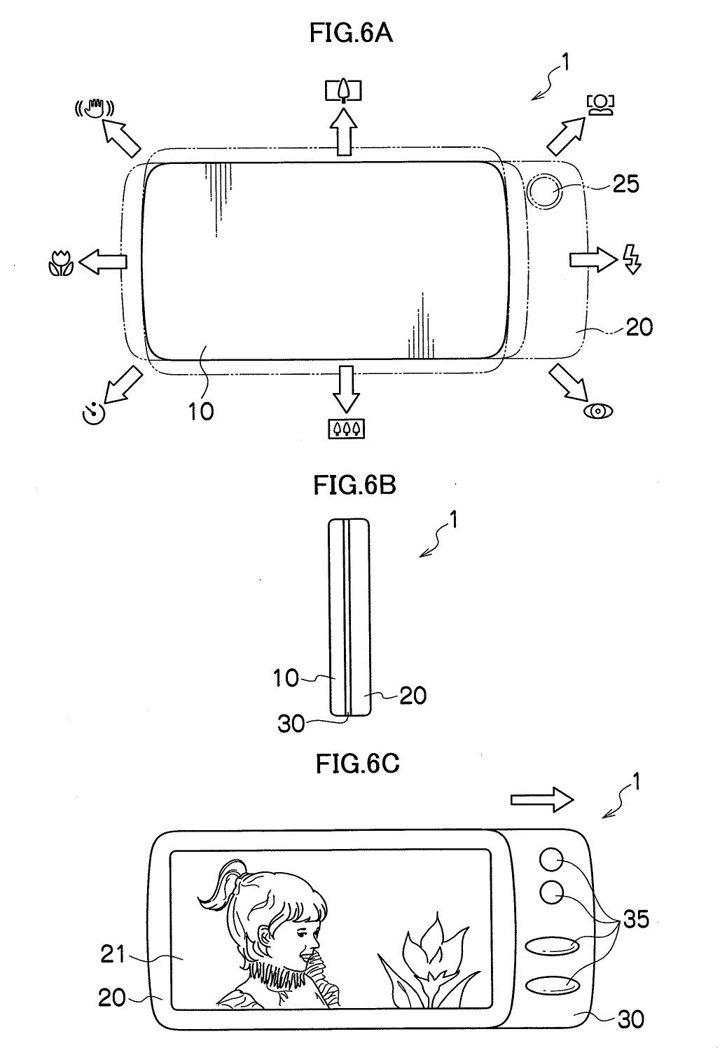

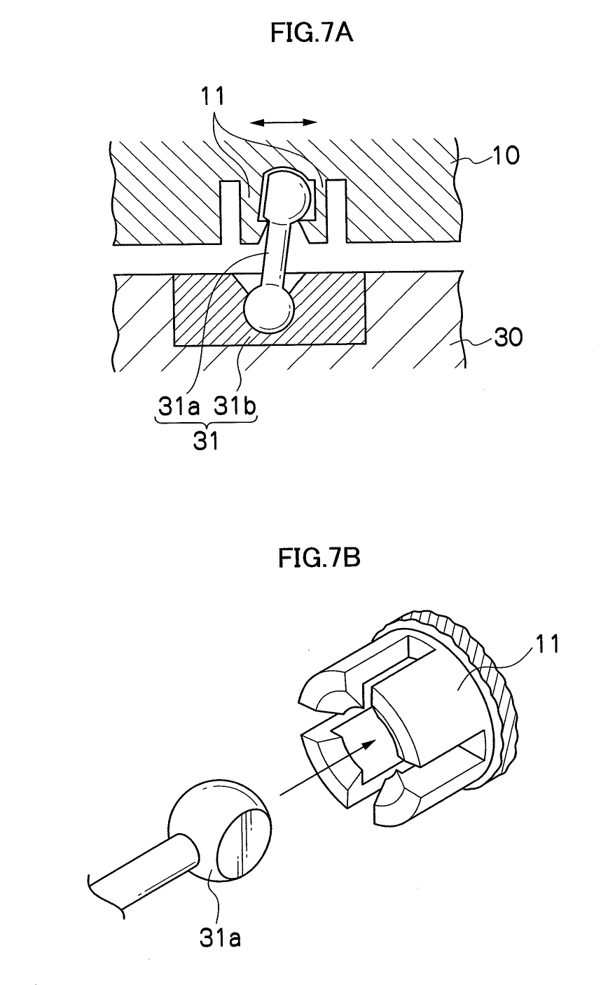

The first enclosure 10 can be operated in eight directions in the first position and the second position. The structure and operation of the first enclosure 10 will be described below with reference to the second position by way of example. FIGS. 6A to 6C are external views showing how the first enclosure 10 is operated in the eight directions in the second position. FIG. 7A is a sectional view showing a state in which the stick switch 31 is fitted to the fitting part 11 formed on the rear face of the first enclosure 10, and FIG. 7B is a perspective view of the fitting part 11.

The substantially spherical part at the tip of the stick 31a, as shown in FIG. 7A, is machined into a substantial D shape, as viewed from above, to prevent it from turning when fitted to the fitting part 11.

The fitting part 11 is formed of four elastic pawls as shown in FIG. 7B. The internal space which the four pawls contain is formed in a substantial D shape, similarly to the substantially spherical part at the tip of the stick 31a, as shown in FIG. 7A so as to fit the tip of the stick 31a.

By placing the fitting part 11 on the tip of the stick 31a and applying an external force from above the first enclosure 10, the four pawls of the fitting part 11 are bent to fit the fitting part 11 and the tip of the stick 31a with each other. This causes the first enclosure 10 and the third enclosure 30 to be fitted via the stick switch 31, and the first enclosure 10 and the third enclosure 30 shift integrally with each other between the first position and the second position.

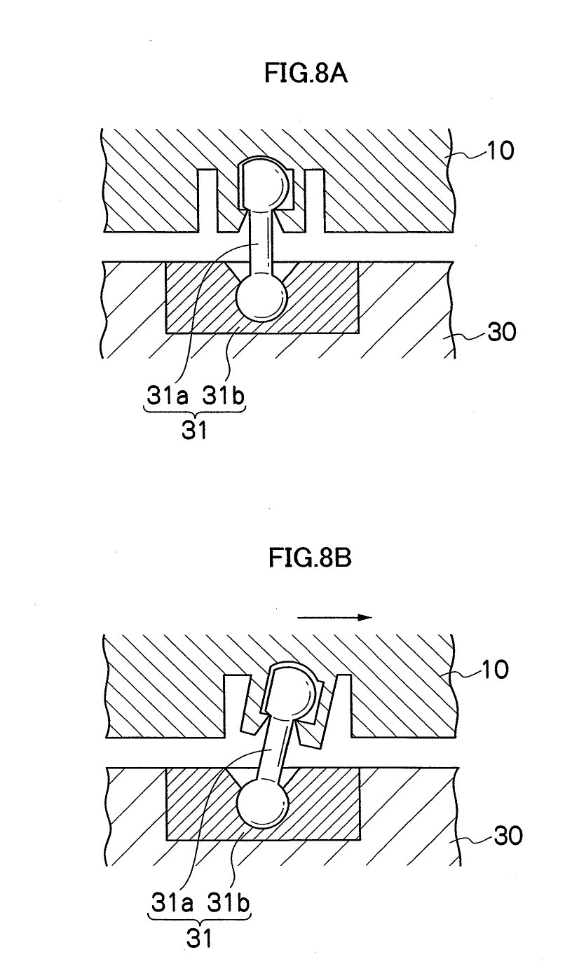

At the same time, by applying an external force to the first enclosure 10, the octa-directional shifting operation of the first enclosure 10, namely the octa-directional lever operation of the stick switch 31, is made possible. The method for operating the first enclosure 10 will be described below. FIG. 8A shows a state in which the stick 31a is in the reference position and FIG. 8B shows a state in which the stick 31a has fallen down and stopped.

When a rightward external force is applied to the first enclosure 10 in its usual state shown in FIG. 8A, the stick 31a is pressed lower-rightward as shown in FIG. 8B, and the shift of the first enclosure 10 is stopped where the downward move of the stick 31a is stopped. Namely, the first enclosure 10 moves (is shifted) by a few mm to a few cm and stops there. After that, when the first enclosure 10 is cleared of the rightward external force applied to the first enclosure in the shifting action, the stick 31a automatically returns to the reference position and, along with its return, the first enclosure 10 also returns to its usual state shown in FIG. 8A.

This arrangement enables various operations to be done without having to manipulate a button or the like. By setting the force required for lever operation of the stick switch 31 weaker than the force applied by the spring 41, the first enclosure 10 can be operated in eight directions in each of the first position and the second position. For instance, when a shift from the second position to the first position is to be accomplished by moving the first enclosure 10 and the third enclosure 30 in parallel, first the stick 31a is inclined rightward by lever operation, and then the first enclosure 10 and the third enclosure 30 are integrally shifted rightward. Although the stick switch 31 detects the rightward inclination of the stick switch 31 when the stick 31a is inclined rightward by lever operation, the detection by the push switch 24 is also performed immediately after the detection by the stick switch 31, thereby eliminating the problem of malfunction or the like.

The third enclosure 30, which is formed smaller than the first enclosure 10, is not made visible even if the first enclosure 10 is shifted by lever operation, resulting in enhancing aesthetic neatness.

Furthermore, as the first enclosure 10 is shifted for only a few mm to a few cm, a far shorter distance than that between the first position and the second position, there is no possibility for the shifting to invite hiding of the shooting lens assembly 25 or the operation unit 35 by the first enclosure 10 and the second enclosure 20.

### [Electrical Configuration of Digital Camera 1]

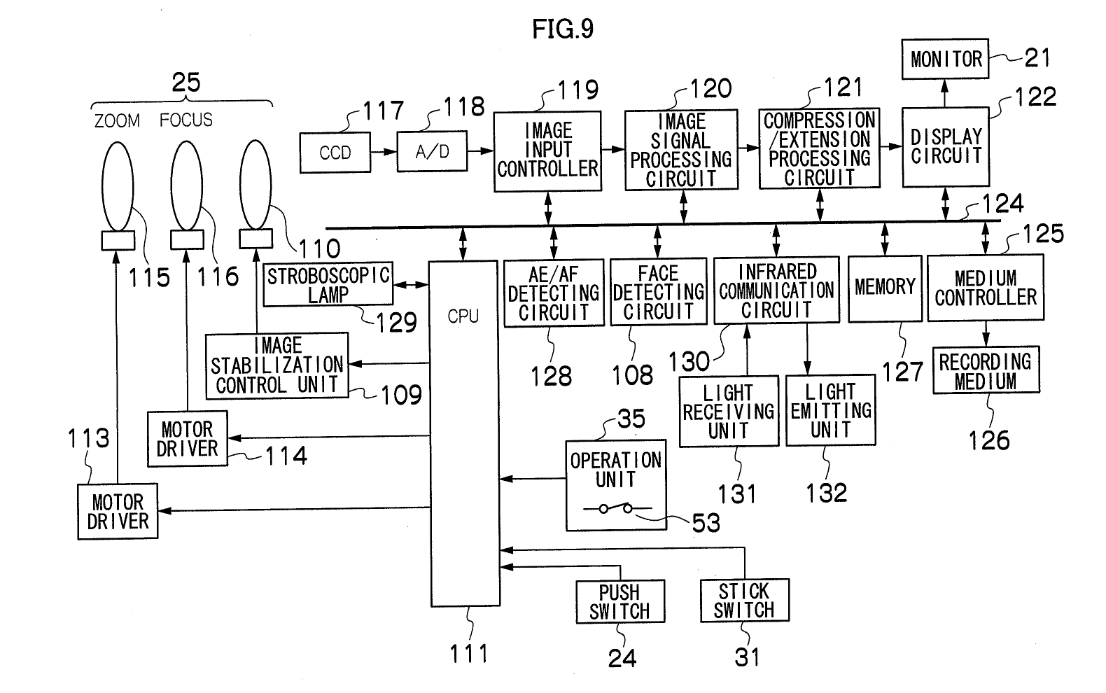

FIG. 9 is a block diagram showing an embodiment of the internal configuration of the digital camera 1.

As shown in FIG. 9, the digital camera 1 as this embodiment of the present invention comprises a CPU 111, the operation unit 35, a motor driver 113 for a zoom lens, a motor driver 114 for a focusing lens, an image stabilization control unit 109, a zoom lens 115, a focusing lens 116, an image stabilizing unit 110, a CCD 117, an A/D converter 118, a image input controller 119, a image signal processing circuit 120, a compression/extension processing circuit 121, a display circuit 122, the monitor 21, a medium controller 125, a recording medium 126, a memory 127, an AE/AF detecting circuit 128, a human face detecting circuit 108, a stroboscopic lamp 129, an infrared communication circuit 130, the push switch 24 and the stick switch 31.

Each part operates under the control of the CPU 111, which controls each part of the digital camera 1 by executing a prescribed control program in accordance with an input from the operation unit 35.

The CPU 111 has a program ROM built therein, and various data required from control in addition to a control program to be executed by the CPU 111 are recorded on this program ROM. The CPU 111 controls each part of the digital camera 1 by consecutively executing elements of this control program.

The operation unit 35 has a power supply button 53, a shutter release button (not shown) and so forth, and outputs to the CPU 111 a signal according to the type of operation to be done.

The shooting lens assembly 25 comprises the zoom lens 115, the focusing lens 116 and the image stabilizing lens 110.

The zoom lens 115, driven by the motor driver 113 for zoom lens, moves back and forth on the optical axis of the focusing lens 116. The CPU 111 controls the shifting of and zooms in and out the zoom lens 115 by controlling the driving of a motor for zoom lens via the motor driver 113 for zoom lens.

The focusing lens 116, driven by the motor driver 114 for focusing lens, moves back and forth on the optical axis of the zoom lens 115. The CPU 111 controls the shifting of the focusing lens 116 and performs focusing by controlling the driving of a motor for focusing lens (not shown) via the motor driver 114 for focusing lens.

The image stabilizing lens 110 is controlled by the image stabilization control unit 109. The image stabilization control unit 109 detects any destabilization of the digital camera 1 with a gyro sensor, and compensates for the destabilization of the object image via the zoom lens 115 and the focusing lens 116 by moving the image stabilizing lens 110 in a direction reverse to that of the destabilization.

The CCD 117, arranged following the image stabilizing lens 110, receives the light reflected from the object having passed the zoom lens 115, the focusing lens 116, and the image stabilizing lens 110. The CCD 117, as is well known, has a light receiving face on which many light receiving elements are arranged in a matrix. The light reflected from the object having passed the zoom lens 115 and the focusing lens 116 forms an image on the light receiving face of this CCD 117 and is converted into electric signals by the light receiving elements.

This CCD 117 outputs the electric charge accumulated on each pixel line by line as serial image signals in synchronism with a vertical transfer clock and a horizontal transfer clock.

As stated above, outputting of image signals begins when the digital camera 1 is set into the shooting mode, and an image through the lens (pass-through image) is displayed on the monitor 21. The outputting of image signals for this image through the lens is temporarily suspended when an actual shooting is instructed, and resumed when the actual shooting is completed.

Also, the CPU 111 lights the stroboscopic lamp 129 as an auxiliary light source for shooting if required for the actual shooting.

The image signals outputted from the CCD 117 are analog signals, which are captured into the AID converter 118.

The A/D converter 118 comprises a correlated double sampling (CDS) circuit and an automatic gain control (AGC) circuit. The CDS removes noise contained in image signals, while the AGC amplifies the noise-cleared image signals with a prescribed gain. The A/D converter 118 converts the analog image signals into digital image signals having a gradation width of prescribed bits. These image signals are so-called RAW data, of which each pixel has gradation values representing the concentrations of R, G and B.

The image input controller 119, having a built-in line buffer of a prescribed capacity, accumulates a single-frame equivalent of image signals outputted from the A/D converter 118. The single-frame equivalent of image signals accumulated in the image input controller 119 is stored into the memory 127 via a bus 124.

To the bus 124, the image signal processing circuit 120, the compression/extension processing circuit 121, the display circuit 122, the medium controller 125, the AE/AF detecting circuit 128, the stroboscopic lamp 129, the infrared communication circuit 130 and so forth are connected in addition to the CPU 111, the image input controller 119 and the memory 127, and these elements can transmit and receive information to and from one another via the bus 124.

The image signals equivalent to a single-frame stored in the memory 127 are captured into the image signal processing circuit 120 in a dot-sequential system (in the order of pixels).

The image signal processing circuit 120 performs prescribed signal processings for the dot-sequentially captured image signals of R, G and B colors, and thereby generates image signals (Y/C signals) comprising luminance signals Y and color difference signals Cr and Cb.

The AE/AF detecting circuit 128, in accordance with a command from the CPU 111, captures, via the image input controller 119, the R, G and B image signals stored in the memory 127, and calculates focus evaluation values needed for automatic focus (AF) control. This AE/AF detecting circuit 128 includes a high pass filter which passes only the high frequency components of G signals, an absolutizing unit (absolute value calculator), a focal area extracting unit which cuts out signals in a prescribed focal area set on the screen and an aggregating unit which aggregates absolute value data in the focal area. And the AE/AF detecting circuit 128 outputs to the CPU 111 as focus evaluation values the absolute value data in the focal area aggregated by this aggregating unit. The CPU 111 searches for the position where the focus evaluation values outputted from this AE/AF detecting circuit 128 reaches their local maximum when under AF control, and achieves focusing on the main object by moving the focusing lens 116 to that position.

Further the AE/AF detecting circuit 128, in accordance with a command from the CPU 111, captures via the image input controller 119 R, G and B image signals stored in the memory 127, and calculates the aggregate sums required for AE control. Thus, this AE/AF detecting circuit 128 divides the target area (one frame) into a plurality of subareas, and calculates an aggregate sum of image signals for each of R, G and B in each subarea. The calculated aggregate sum information for each of R, G and B in each subarea is stored into the memory 127.

The CPU 111 calculates an exposure value from the aggregate sum calculated by the AE/AF detecting circuit 128, and sets exposure based on this exposure value. In this exposure setting, the diaphragm stop and the shutter speed are determined in accordance with prescribed program lines.

The human face detecting circuit 108 detects a human face area from image signals stored in the memory 127. For this face area detection, first a prescribed number of resized images differing in resolution are prepared for the image which is subject to the detection. Then, one or more areas which correspond to one or more image data among a plurality of face image data of a prescribed size prepared in advance are extracted from each resized image. A resized image in which the number of extracted areas is the greatest is selected, the extracted areas within the selected resized image are enlarged or reduced to a size corresponding to the image before the resizing, and the areas thereby obtained are identified as the faces of the object. Finally, the number, coordinates and sizes of detected face areas, are outputted.

The compression/extension processing circuit 121, in accordance with a compression command from the CPU 111, performs compression processing for the inputted image signals (Y/C signals) comprising luminance signals Y and color difference signals Cr and Cb in a prescribed form (e.g. JPEG) to generate compressed image data. In addition, in accordance with an extension command from the CPU 111, the circuit performs extension processing for the inputted compressed image data in a prescribed form to generate non-compressed image data.

The display circuit 122, in accordance with a command from the CPU 111, controls displaying on the monitor 21. That is, following the command from the CPU 11, the display circuit 122 converts image signals successively inputted from the memory 127 into video signals to be displayed on the monitor 21 (e.g. NTSC (National Television System Committee) signals, PAL (Phase Alternation by Line) signals and SECAM (Sequential Couleur A Memorie) signals) and outputs the converted signals to the monitor 21. Also, as required, the display circuit 122 mixes with the image signals characters, graphical figures, signs and so forth to be displayed on the monitor 21, and causes the monitor 21 to display prescribed characters, graphical figures, signs and so forth.

The medium controller 125, in accordance with a command from the CPU 111, controls data reading or writing onto or out of the recording medium 126. The recording medium 126 may either be detachable from the camera body, such as a memory card, or built into the camera body. When a detachable recording medium is to be used, a card slot may be provided in the camera body to allow the card to be inserted.

The infrared communication circuit 130, in accordance with a command from the CPU 111, communicates with external equipment by infrared rays. The infrared communication circuit 130 modulates the data to be transmitted, and sends the modulated data from a light emitting unit 132 to external equipment. The infrared communication circuit 130 also receives with a light receiving unit 131 data transmitted from external equipment, and demodulates the received signals.

The push switch 24, as stated above, detects the first position and the second position of the digital camera 1. The push switch 24 outputs a signal indicating its on/off state, and the CPU 111 is enabled to detect the first position and the second position by analyzing this output signal.

The stick switch 31 detects any operation to shift the first enclosure 10. A signal corresponding to the direction of the shifting operation is outputted from the stick switch 31, and the CPU 111 is enabled to recognize the direction of the shifting operation by analyzing this output signal.

### [Actions of Digital Camera 1]

Next, the actions of the digital camera 1 of this embodiment configured as stated above will be described. Power supply to the digital camera 1 is turned on, and the camera is made operable, by manipulating the power supply button 53. Placing the digital camera 1 in the first position when the power supply is on results in selection of the reproduction mode, while placing the digital camera 1 in the second position causes the shooting mode to be selected. The user can configure detailed mode setting by shifting the first enclosure 10 in one or the other position.

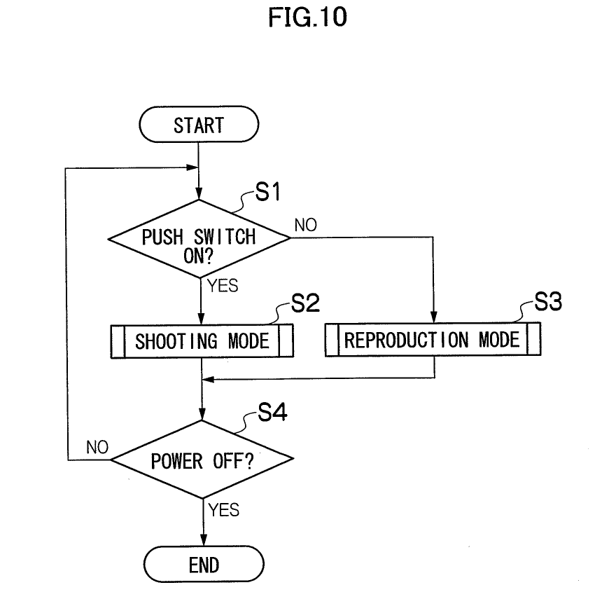

Mode setting for the digital camera 1 will be described below with reference to FIG. 10.

When the power supply button 53 is turned on to actuate power supply to the digital camera 1, first it is determined whether or not the push switch 24 is on (step S1). If the push switch 24 is determined to be on, the CPU 111 judges that the digital camera 1 is in the second position and sets the camera into the shooting mode (step S2). If the push switch 24 is determined to be off, the CPU 111 judges that the digital camera 1 is in the first position and sets the camera into the reproduction mode (step S3). In this way, the mode is switched over according to the state of the push switch 24.

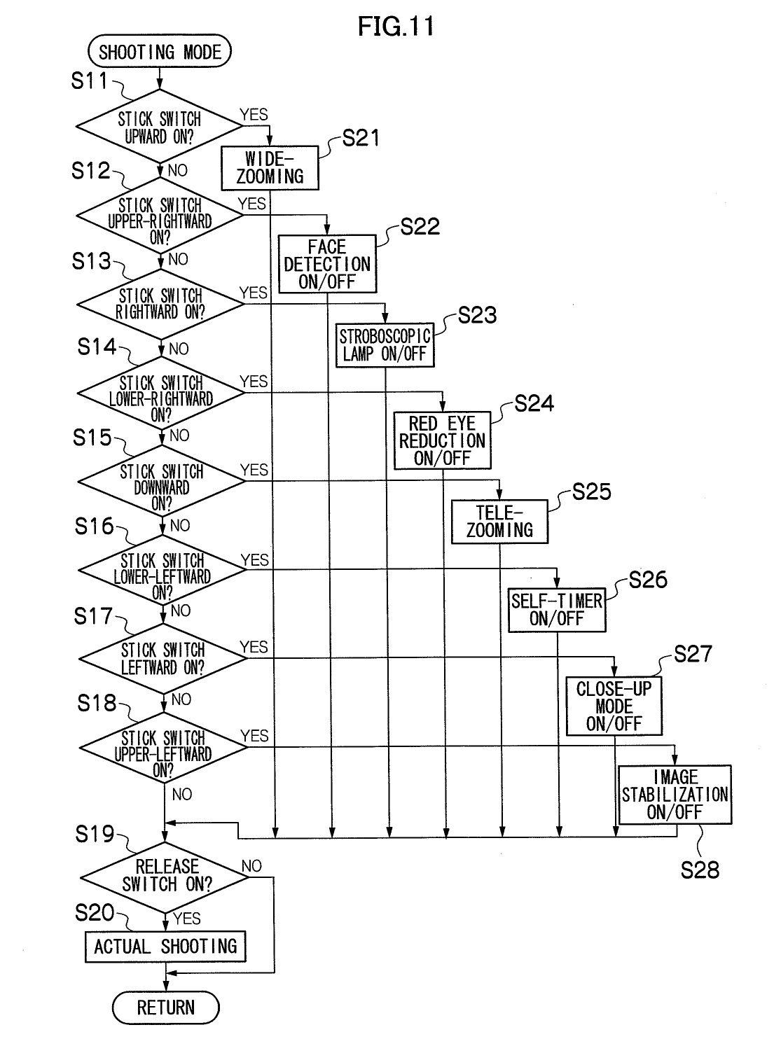

First, operations in the shooting mode will be described with reference to FIG. 11. FIG. 6A shows the relationship between the manipulating directions and the operations in the shooting mode.

When the user shifts the first enclosure 10 upward in the shooting mode, the stick 31a of the stick switch 31 is inclined upward, and the switch part 31b detects this upward inclination of the stick 31a. In response, the stick switch 31 outputs a signal corresponding to the upward turning on. Analyzing this output signal of the stick switch 31, the CPU 111 detects that the upward shifting operation has been done (step S11). Further on the basis of the result of this detection, the CPU 111 drives the zoom lens 115 via the motor driver 113 for zoom lens to zoom toward the wide side (step S21).

When the user shifts the first enclosure 10 upper-rightward as viewed from the object, the stick switch 31 detects the upper-rightward motion of the first enclosure. The CPU 111 operates the human face detecting circuit 108 on the basis of the signal output corresponding to the upper-rightward turning-on of the stick switch 31 (step S12), detects the human face in the object, and displays the result of detection on the monitor 21 (step S22). The CPU 11 also makes the AE/AF detecting circuit 128 work to obtain proper focusing and exposure of the detected face. By shifting the first enclosure 10 upper-rightward as viewed from the object once again, the face detection can be canceled.

When the user shifts the first enclosure 10 rightward as viewed from the object, the stick switch 31 detects the rightward motion of the first enclosure. The CPU 111 sets the stroboscopic shooting mode according to an output signal of the stick switch 31 (step S13), and charges the large capacity capacitor of the stroboscopic lamp 129 to prepare for its lighting at the time of the actual shooting (step S23). By shifting the first enclosure 10 rightward as viewed from the object once again, the stroboscopic shooting mode can be canceled.

Here, in this case, where the first enclosure 10 is shifted rightward as viewed from the object, the shifting direction of the first enclosure 10 is the same as the shifting direction toward the first position in which the first enclosure and the second enclosure overlap each other. However, it is possible to just shift the first enclosure 10 without moving to the first position because the force required for lever operation of the stick switch 31 is set to be weaker than the pressing force of the spring 41 as stated above.

Further, the user can set the red eye reducing stroboscopic shooting mode, zooming toward the tele side, self-timer mode, close-up mode and image stabilizing mode by shifting the first enclosure 10 lower-rightward, downward, lower-leftward, leftward and upper-leftward, respectively, as viewed from the object and thereby causing the CPU 111 to respond to the output signals from the stick switch 31 in the respective directions (steps S14 through S18), and control the operations in the respective modes (steps S24 through S28). In the same way as described above, manipulation for shifting a plurality of times in the same direction causes the turning on and off in the corresponding mode to be repeated.

The user can check whether or not the desired mode has been properly set by a display on the monitor 21.

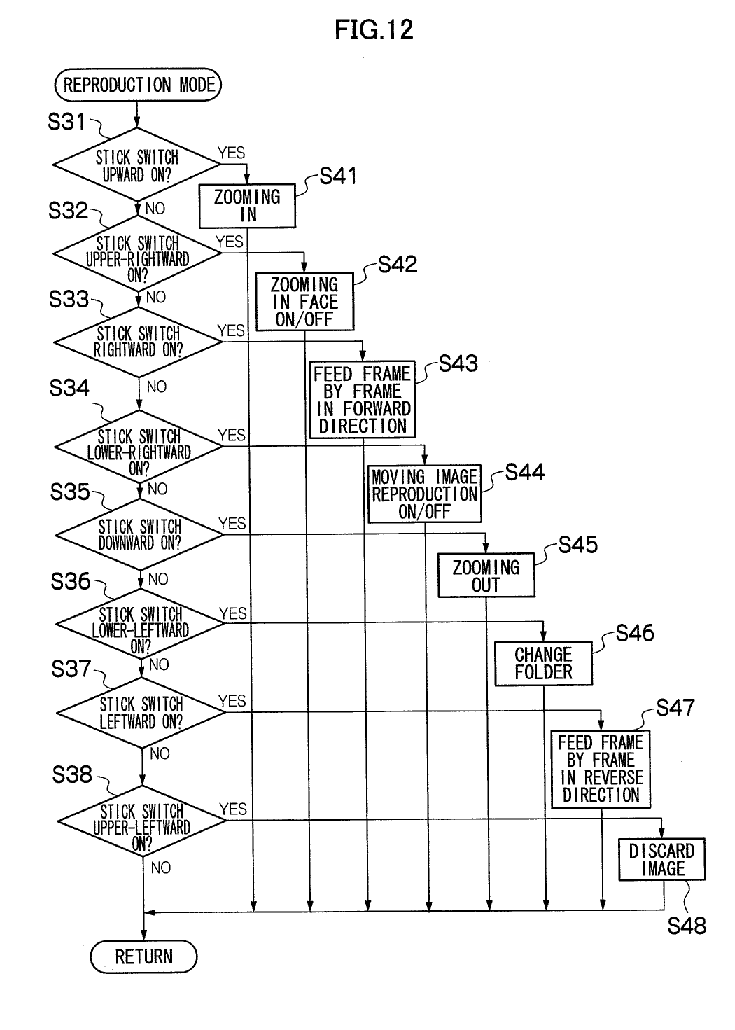

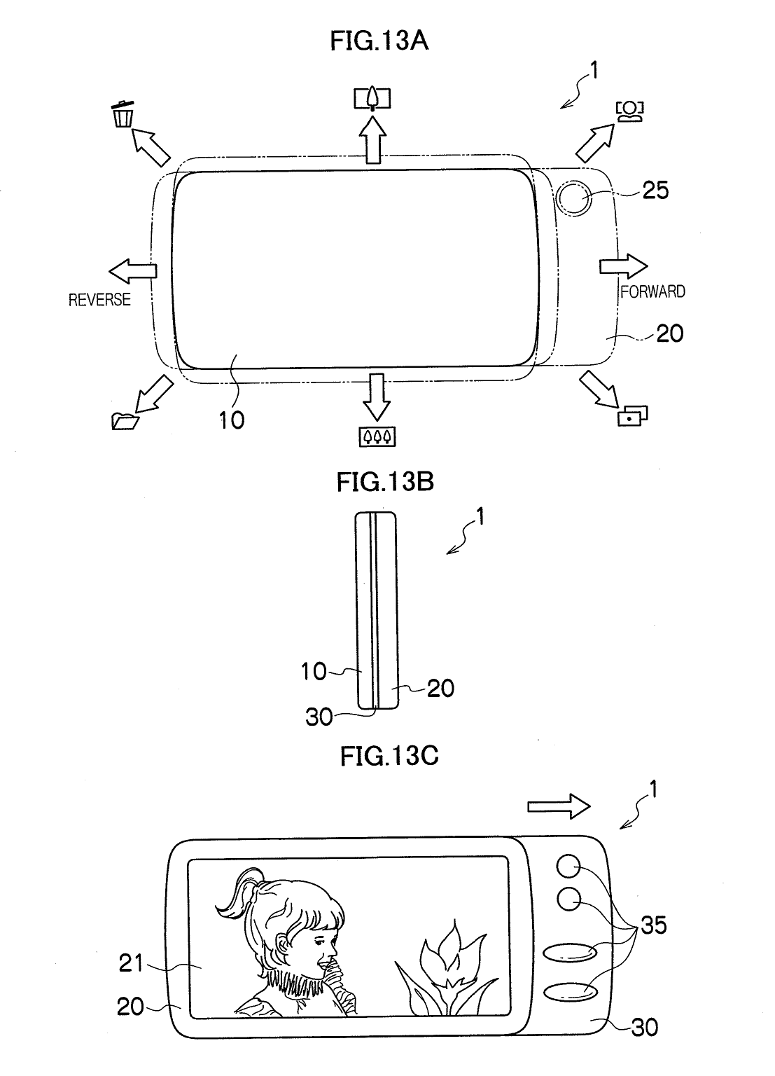

Next, the reproduction mode will be described with reference to FIG. 12. FIG. 13A shows the relationship between the manipulating directions and the actions in the reproduction mode.

When the camera is set into the reproduction mode, the image file of the last frame recorded in the recording medium 126 is read out via the medium controller 125. Compressed data of this image file that has been read out are extended into non-compressed YC signals via the compression/extension processing circuit 121.

The extended YC signals are converted into a signal form for the displaying purpose by the display circuit 122, and the converted signals are outputted to the monitor 21. This output results in displaying of the last frame recorded in the recording medium 126 on the monitor 21.

When the user shifts the first enclosure 10 upward in this state, the stick 31a of the stick switch 31 is inclined upward, and the switch part 31b detects the upward inclination of the stick 31a. In response, the stick switch 31 outputs a signal corresponding to the upward turning on. Analyzing this output signal of the stick switch 31, the CPU 111 detects the upward shifting operation having been done (step S41). Further on the basis of the result of this detection, the CPU 111 zooms in the image displayed on the monitor 21 by using the image signal processing circuit 120 (step S41). Every time an upward shifting operation is taken here, the zooming magnification rate is raised. Alternatively, the zooming magnification rate may as well be continuously raised along with the detection of a shift maintained over at least a prescribed length of time.

When the user shifts the first enclosure 10 upper-rightward as viewed from the object, the stick switch 31 detects the upper-rightward motion of the first enclosure 10. The CPU 111, by using the human face detecting circuit 108 and the image signal processing circuit 120, causes the facial part in the image displayed on the monitor 21 to be zoomed in (step S42) on the basis of the signal output corresponding to the upper-rightward turning-on of the stick switch 31 (step S32). Every time an upper-rightward shifting operation is taken here, the display zooms in a different face. When every face on the screen has been zoomed in and a further upper-rightward shifting operation is taken, zoomed-in displaying is turned off to return to normal screen displaying.

When the user shifts the first enclosure 10 rightward as viewed from the object, the stick switch 31 detects the rightward motion of the first enclosure 10. The CPU 111 feeds frame by frame the images to be displayed on the screen in the forward direction (step S43) correspondingly to output signals of the stick switch 31 (step S33). The image file in the frame position fed frame by frame is read out of the recording medium 126 and images are reproduced on the monitor 21 in the same way as described above.

Further, the user can cause the CPU 111 to control actions of turning on or off moving images, zooming out, changing the folder of images to be reproduced, frame-by-frame feeding in the reverse direction and image discarding (step S44 to S48) correspondingly to the output signals of the stick switch 31 in different directions by shifting the first enclosure 10 lower-rightward, downward, lower-leftward, leftward and upper-leftward, respectively, as viewed from the object. The respective actions corresponding to the shift operations in the eight directions may as well be displayed on the monitor 21.

When the first enclosure 10 is shifted leftward as viewed from the object, though the moving direction of the first enclosure 10 is the same as the shifting direction toward the second position in which the first enclosure and the second enclosure do not overlap each other. However, it is possible to just shift the first enclosure 10 without moving to the second position as described above.

According to this embodiment of the present invention, the equipment can be driven in various operating modes or operated in many different ways by shifting the enclosures without having to manipulate a button or the like. Also, by varying the operating mode between the first position and the second position, the equipment can be made adaptable to many different operating modes.

Furthermore, this embodiment needs no manipulation of a button or the like because the equipment is operated by shifting the enclosures. For this reason, the required number of buttons and such items can be reduced, with corresponding contributions to enhancing aesthetic neatness and reducing the overall cost.

Also, the holding of the first enclosure and the third enclosure immovable relative to the second enclosure in the first position and the second position in this embodiment can prevent the enclosures from moving inadvertently and from consequent unintended operation.

Incidentally, with a view to improve operating ease in this embodiment, the first enclosure 10 automatically returns to its normal state along with the automatic return of the stick 31a to its reference position when the external force applied to the first enclosure 10 is eliminated in shifting operation, but it is not absolutely necessary to enable the stick 31a and the first enclosure 10 to automatically return. For instance, a combination of allowing self-return and forbidding self-return, differentiated by the extent of shifting of the first enclosure 10, is conceivable. This could further enhance the operating ease.

Although setting is done in various ways according to the output signal of the stick switch 31 by shifting the first enclosure 10 and the action in each mode is controlled in accordance with the setting in this embodiment, the choice of setting may as well be determined by pushing the first enclosure 10 in the direction away from the user after shifting the first enclosure 10, followed by the control of the action in each mode according to the determined setting. This action is made possible by the use of a stick switch 31 whose switch part 31b can detect the pushing of the stick 31a. In this case, the stick switch 31 is so configured that the stick 31a is automatically returned to its reference position when the external force is eliminated after the pushing operation.

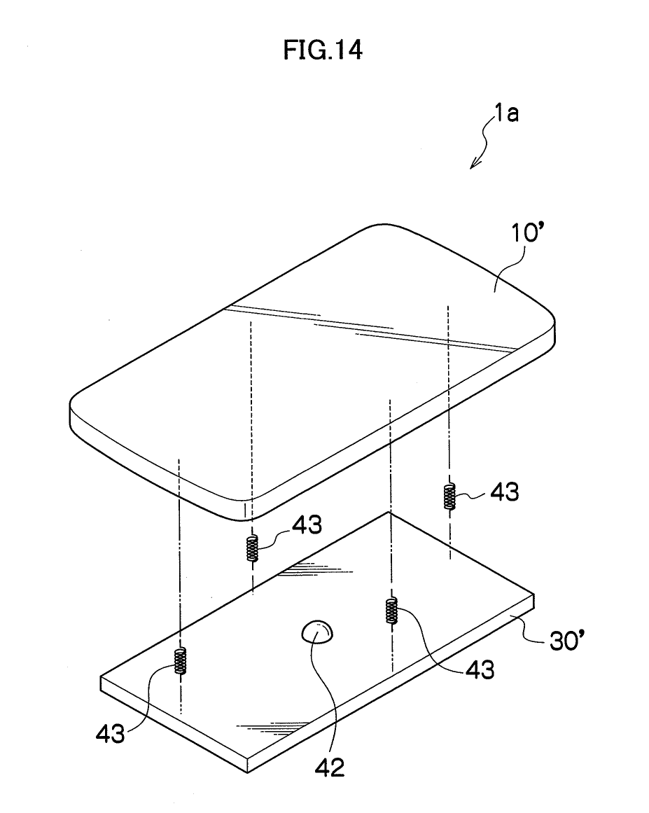

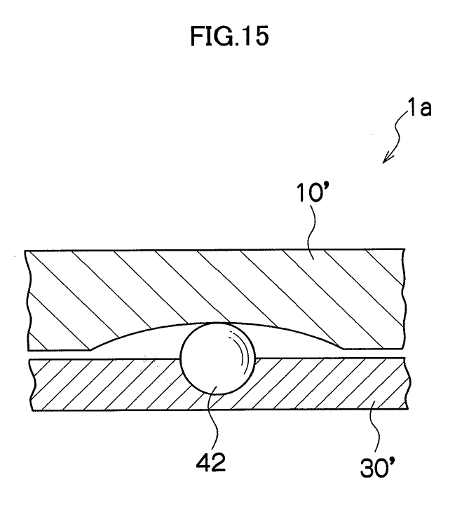

Further in this embodiment, the first enclosure 10 and the third enclosure 30 are so linked via the stick switch 31 as to enable the first enclosure 10 to be manipulated in eight directions, the linking method is not limited to this one, but another method shown in FIG. 14 and FIG. 15 may be used as well.

The linking mechanism comprises a track ball 42 and springs 43. The first enclosure 10 and the third enclosure 30 are linked in four positions by the springs 43. A recess each is formed in the first enclosure 10 and the third enclosure 30, and the track ball 42 is held by the recess formed in the first enclosure 10 and by that in the third enclosure 30. This arrangement enables the track ball 42 to turn in all directions. By setting the force required for turning the track ball 42 weaker than the pressing force of the spring 41, the first enclosure 10 is enabled to be manipulated in multiple directions in both the first position and the second position.

The turning of the track ball 42 and its direction and extent are detected by detecting elements such as Hall elements or encoders (not shown) arranged in the third enclosure 30. A digital camera 1a is driven in a driving mode corresponding to the result of detection. By rotationally manipulating the track ball 42, operations in all directions are made possible, including direct switching over from the rightward to the upward direction. Where the track ball 42 is used, a configuration allowing push operations can also be used.

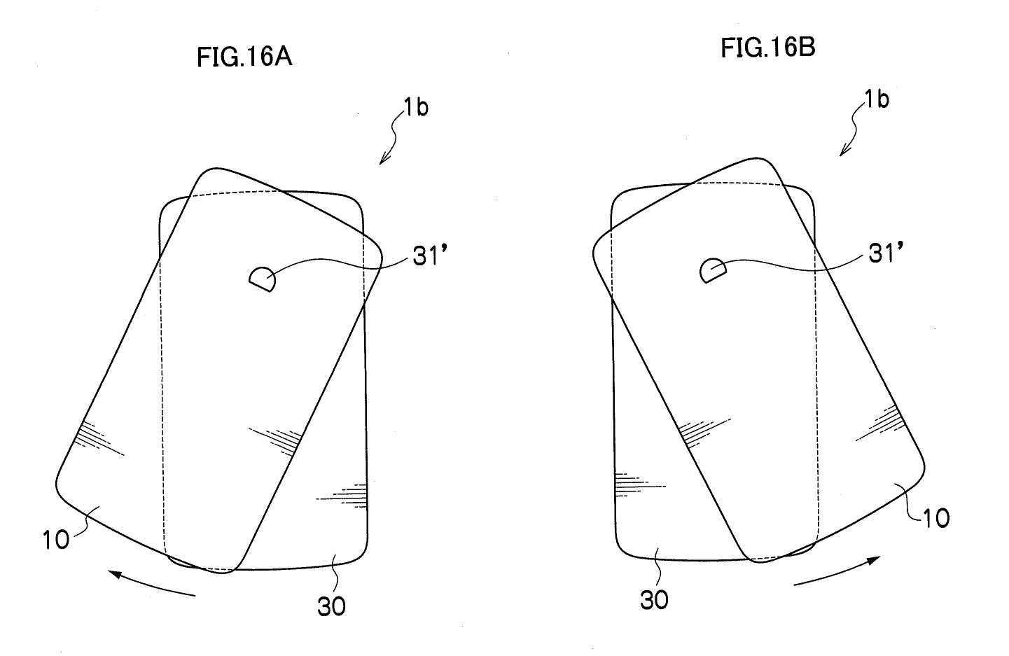

Although the first enclosure 10 and the third enclosure 30 are linked via the stick switch 31 in this embodiment to enable the first enclosure 10 to be operated in eight directions, the first enclosure 10 may be enabled to be operated not only in eight directions but also in swinging directions as shown in FIGS. 16A and 16B. In this case, a stick switch 31 permitting octa-directional lever operation and detection, and swinging operations and detection both clockwise and counterclockwise can be used. By so configuring the stick switch 31 as not to self-return after the swinging operation, its manipulating ease can be improved.

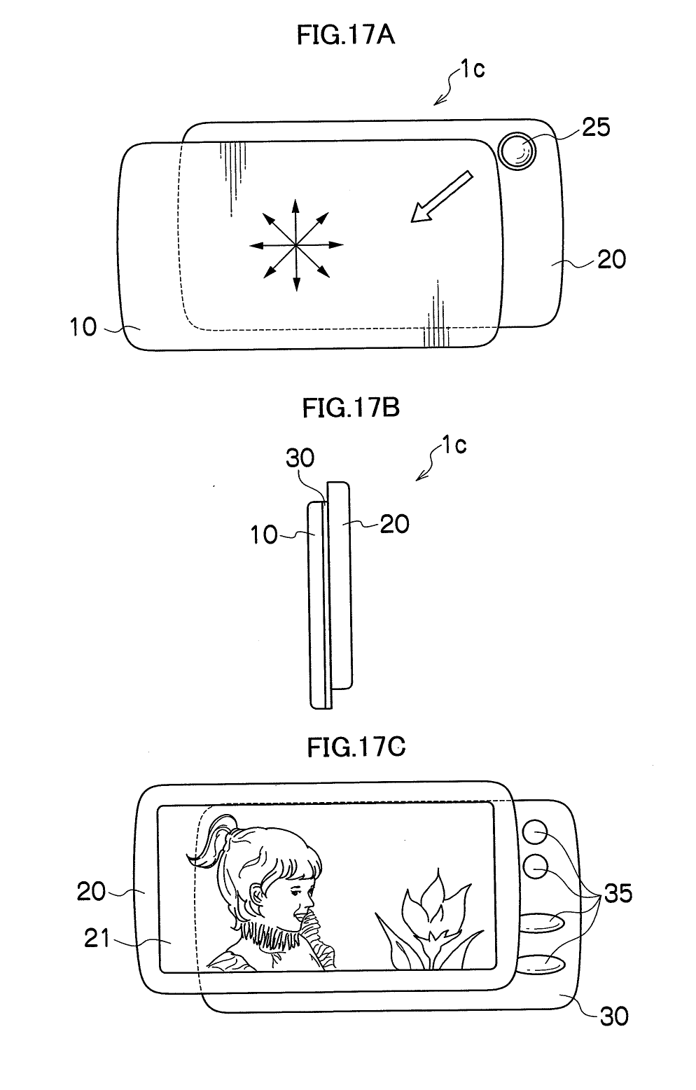

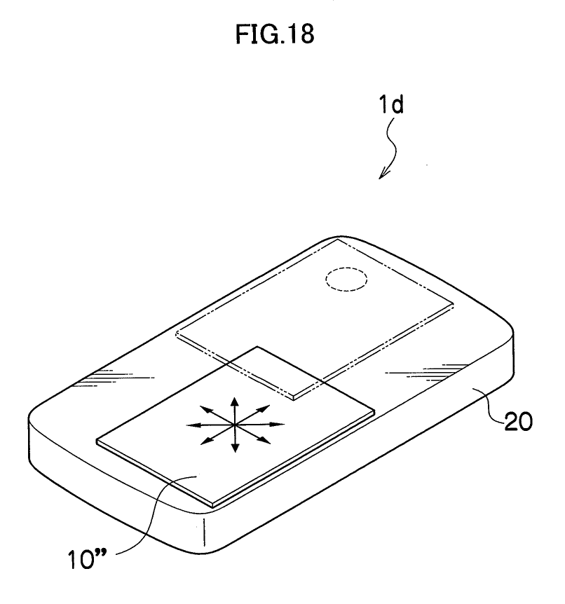

Also, though the first enclosure 10 is shifted from the first position to the second position in this embodiment by moving the first enclosure in parallel leftward as viewed from front, the direction of parallel shifting is not limited to leftward. It may as well be rightward, upward, downward or oblique. For instance, FIGS. 17A to 17C show external views of a case in which the first enclosure 10 is parallel shifted obliquely lower-leftward as viewed from front, wherein FIG. 17A is a front view, FIG. 17B is a profile and FIG. 17C is a rear view. In FIGS. 17A to 17C, the first enclosure 10 and the second enclosure 20 are as large, but a first enclosure 10″ may be smaller than the second enclosure 20 as shown in FIG. 18, so that the first enclosure 10″, even when the first enclosure 10″ has been shifted in parallel, does not bulge out of the surface area of the second enclosure 20. In this way, the ease of shifting after the parallel shift can be enhanced.

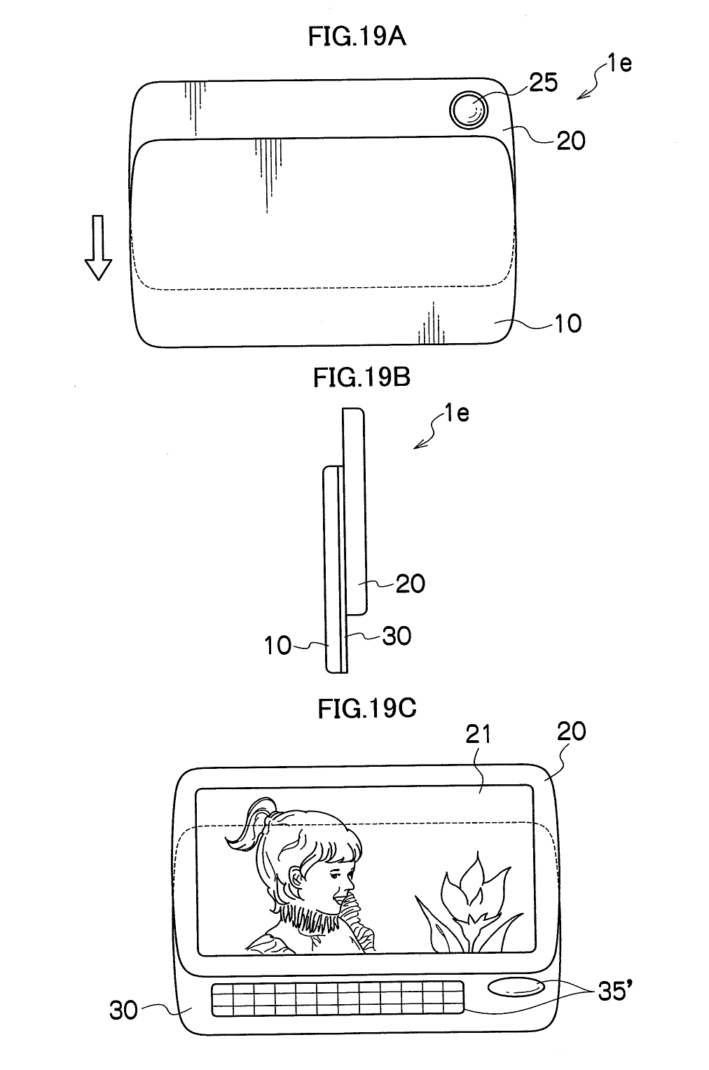

FIGS. 19A to 19C show external views of a case in which the first enclosure 10 is shifted parallel downward as viewed from front, wherein FIG. 19A is a front view, FIG. 19B is a profile and FIG. 19C is a rear view. Incidentally, by exposing a keyboard 35′ as an operation unit in the configuration shown in FIGS. 19A to 19C, this version can also be used as a mobile personal computer or a game machine.

### Modified Version of First Embodiment

In the first embodiment of the present invention, power supply to the digital camera 1 is turned on by manipulating the power supply button 53, and the reproduction mode is selected when the digital camera 1 in that state is placed in the first position or the shooting mode is selected when it is placed in the second position. In this case, the position of the first enclosure 10 and the control of power supply to the digital camera 1 may as well be interlocked with each other.

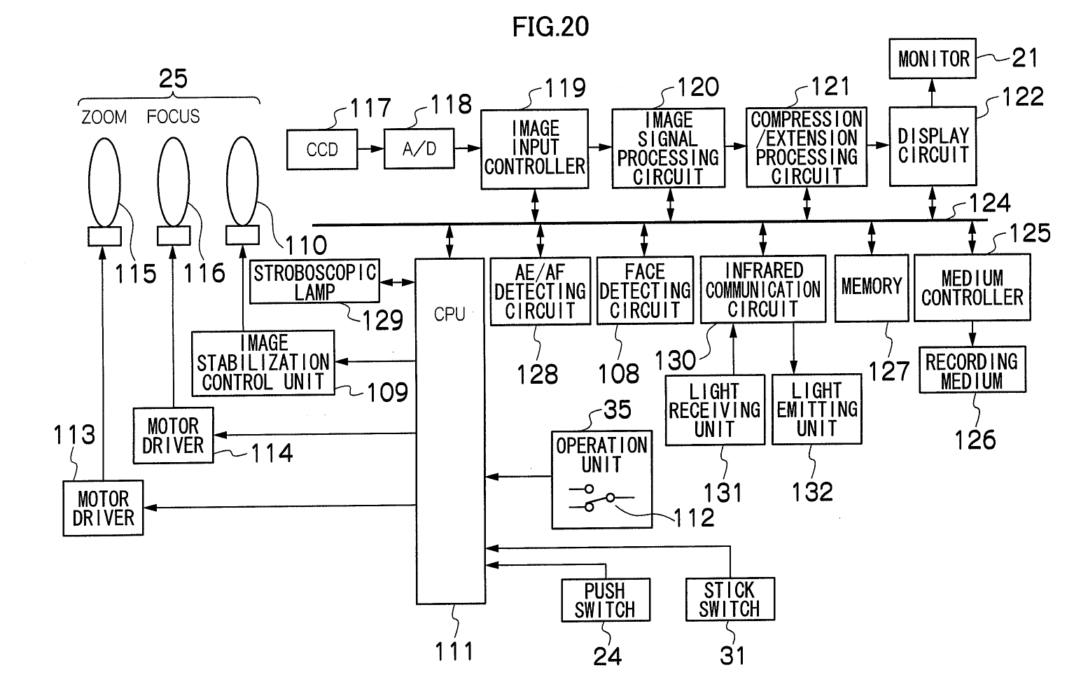

FIG. 20 is a block diagram showing the internal configuration of the digital camera 1, according to another modified version of the first embodiment of the present invention. It differs from the block diagram of FIG. 9 in that the operation unit 35 is provided with a mode change-over switch 112.

In this embodiment, the push switch 24 is interlocked with the control of power supply to the digital camera 1. In the first position, power supply is off, while it is turned on in the second position to enable the functions of the camera to be performed. In the second position, the user can set the digital camera 1 into the shooting mode or the reproduction mode by manipulating the mode change-over switch 112. In the second position, the user can perform more detailed mode setting by shifting the first enclosure 10.

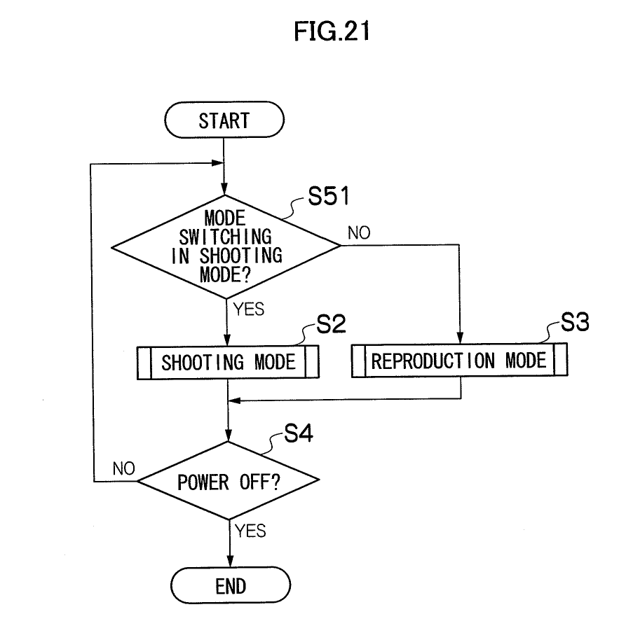

The actions of the digital camera 1 will be described with reference to FIG. 21. Steps in common with the flow chart of FIG. 10 will be assigned respectively the same reference signs, and their detailed description is omitted.

When a shift from the first position to the second position takes place and power supply to the digital camera 1 is turned on, the CPU 111 determines the state of the mode change-over switch 112 (step S51). The CPU 111 judges that the mode change-over switch 112 is set in the shooting mode, the CPU 111 sets the digital camera 1 in the shooting mode (step S2). Or if the CPU 111 judges that the mode change-over switch 112 is set in the reproduction mode, the CPU 111 sets the digital camera 1 in the reproduction mode (step S3).

The actions in the shooting mode and the reproduction mode are respectively the same as those in the shooting mode and the reproduction mode shown in FIGS. 11 and 12.

It is thus conceivable also to have a change between the first position and the second position detected by a switch and interlock this detection with power supply control to validate shifting in the second position. In this way, the manipulation of enclosures and the turning-on of power supply can be interlocked to enhance the manipulating ease.

### Second Preferred Embodiment

While the first preferred embodiment of a portable device pertaining to the present invention represents an application of the present invention to the digital camera 1, the present invention can also be realized in forms other than a digital camera.

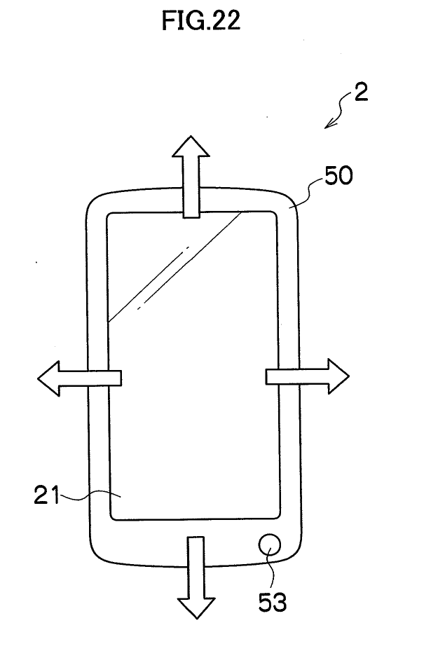

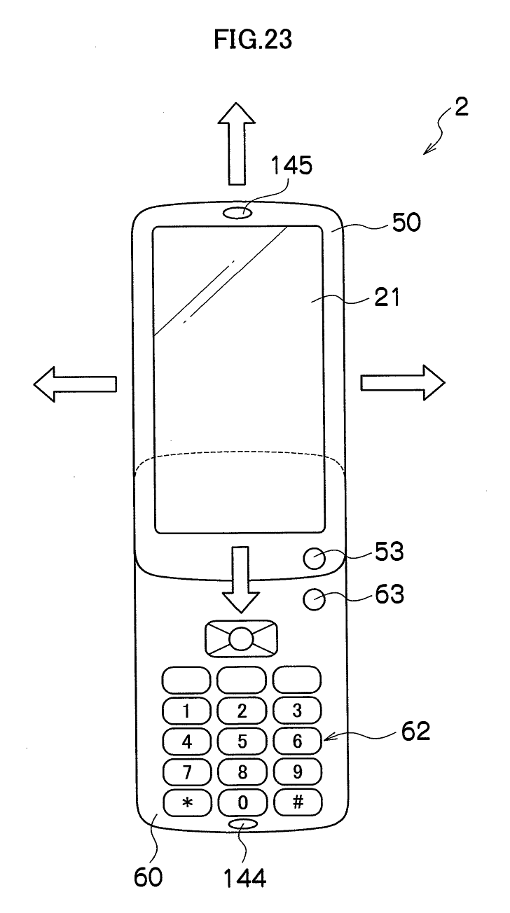

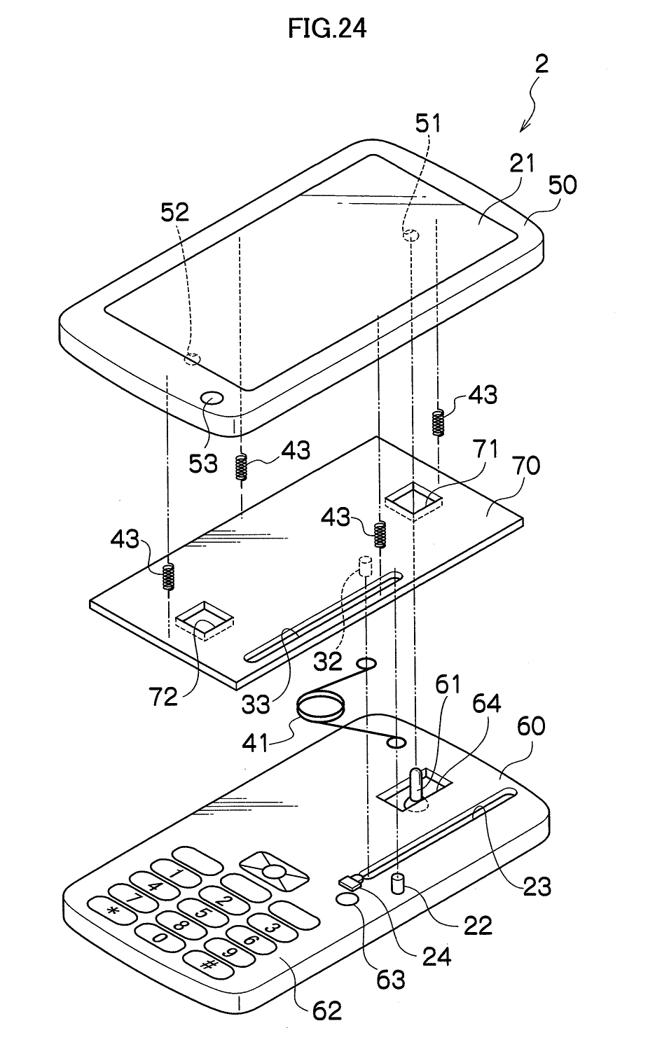

A portable device pertaining to a second preferred embodiment of the present invention represents the application of the present invention to a mobile telephone. FIG. 22 and FIG. 23 show external views of a mobile telephone 2, according to the first embodiment of the present invention; FIG. 22 shows the mobile telephone 2 when silhouettes of a first enclosure 50, a second enclosure 60 and a third enclosure 70 thereof overlap one another in a first position, while FIG. 23 shows the mobile telephone 2 when the first enclosure 50, the second enclosure 60 and the third enclosure 70 have been moved in parallel from the first position to a second position. FIG. 24 shows an exploded perspective view of essential parts of the mobile telephone 2. The same parts as their counterparts in the first embodiment are assigned respectively the same reference signs, and their description will be omitted.

The mobile telephone 2 is composed mainly of the first enclosure 50, the second enclosure 60 and the third enclosure 70. As shown in FIG. 22, the first position is a stored state in which only the monitor 21 and the power supply button 53 are exposed. The second position, as shown in FIG. 23, is a state of use in which operation units including a numeric keypad 62 and call button 63 are exposed in addition to the monitor 21 and the power supply button 53, wherein calling, e-mailing and the like can be done.

### [Configuration of Mobile Telephone 2]

The first enclosure 50 is a substantially rectangular prismatic member, on whose front face the monitor 21 and power supply button 5 are mainly arranged. On the rear face of the first enclosure 10, recesses 51 and 52 which accept fitting of the tip of a stick switch 61 fastened to the second enclosure 60 are formed.

The second enclosure 60 is a substantially rectangular prismatic member of approximately the same size as the first enclosure 10, and on its front face the boss 22, the long hole 23, the push switch 24, the stick switch 61, the numeric keypad 62, the call button 63, a long hole 64 and so forth are mainly arranged. The long hole 64 is formed in a width adequate for detection in the right and left direction of the stick switch 61.

The third enclosure 70 is a substantially rectangular planar member smaller than the first enclosure 50 and the second enclosure 60, and on its rear face the boss 32 and the long hole 33 are mainly arranged. Also, substantially rectangular holes 71 and 72 which permit penetration of a stick 61a of the stick switch 61 are bored therein.

The stick switch 61 includes the stick 61a and a switch part 61b which detects the motions of the stick 61a, wherein the stick 61a can be inclined in four crossing directions (upward, downward, leftward and rightward) by lever operation. The switch part 61b can detect any fall of the stick 61a and the direction of the fall.

The first enclosure 50 and the second enclosure 60 are electrically connected by a flexible printed circuit board (not shown). The first enclosure 50 and the third enclosure 70 are linked in four positions by four springs 43 which apply tensile forces. A regulating mechanism (not shown) is arranged between the first enclosure 50 and the third enclosure 70 to so link the enclosures that the first enclosure 50 can shift relative to the third enclosure 70 by prescribed distances (a few mm to a few cm) only in cross directions but in no other directions.

### ((On Mechanism Regarding Shifts Between First Position and Second Position))

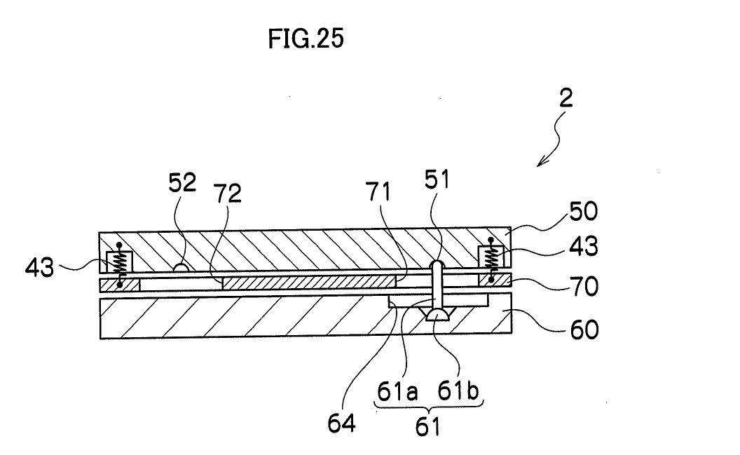

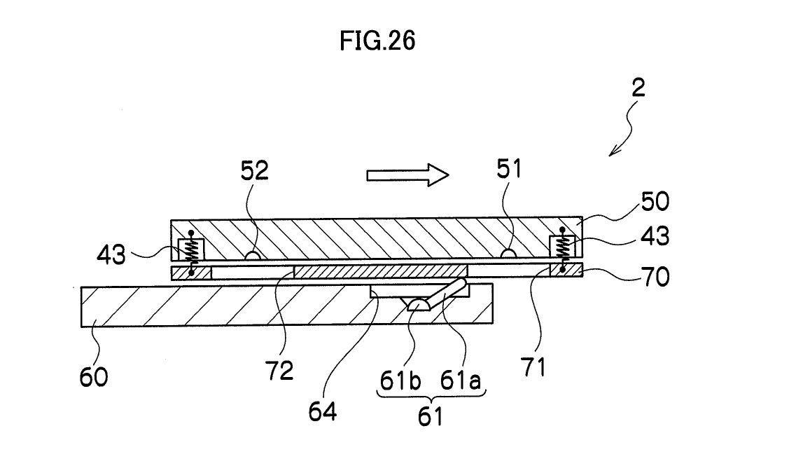

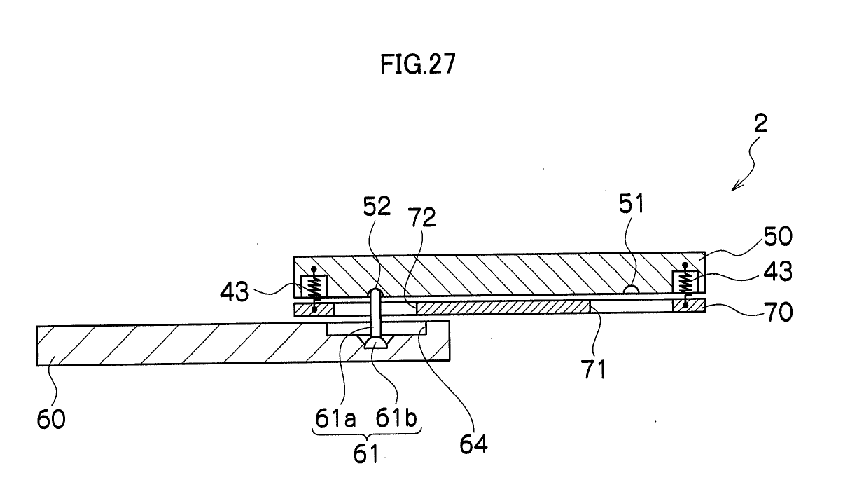

FIG. 25 is a sectional view showing a case in which the first enclosure 50, the second enclosure 60 and the third enclosure 70 are in the first position; FIG. 26 is a sectional view showing a case in which the first enclosure 50, the second enclosure 60 and the third enclosure 70 are being shifted from the first position to the second position, and FIG. 27 is a sectional view showing a case in which the first enclosure 50, the second enclosure 60 and the third enclosure 70 are in the second position. The configuration of the linking mechanism which movably links the first enclosure 50 and the third enclosure 70 with the second enclosure 60 is the same as in the first embodiment, and its description therefore will be omitted here.

In the first position, as shown in FIG. 25, the stick 61a penetrating the hole 71 fit into the recess 51 thereby to fix the first enclosure 50, the second enclosure 60 and the third enclosure 70 in this first position.

In the first position, when it is attempted to shift the first enclosure 50 and the third enclosure 70 leftward against the pressing force of the spring 41, first the first enclosure 50 begins moving relative to the third enclosure 70, and when the shifting of the first enclosure 50 is regulated by a regulating device (not shown), the first enclosure 50 and the third enclosure 70 integrally begin parallel shifting relative to the second enclosure. When the first enclosure 50 and the third enclosure 70 are further shifted, the falling of the stick 61a in the hole 64 as shown in FIG. 26 enables the second enclosure 60 to shift in parallel along the rear face of the third enclosure 70.

When the first enclosure 50, the second enclosure 60 and the third enclosure 70 reach the second position, the stick 61a returns to its reference position and penetrates the hole 72 as shown in FIG. 27, resulting in fitting of the stick 61a into the recess 52. This causes the first enclosure 50 and the third enclosure 70 to be fixed in the second position.

In the shifting from the first position to the second position, the shift of the first enclosure 50 until the shift is regulated by the regulating device (not shown) is detected by the stick switch 61 (to be described in detail afterwards). However, as detection by the push switch 24 takes place immediately after the detection by the stick switch 61, no such problem as erroneous action occurs.

### ((On Mechanism Regarding Operation of First Enclosure 50))

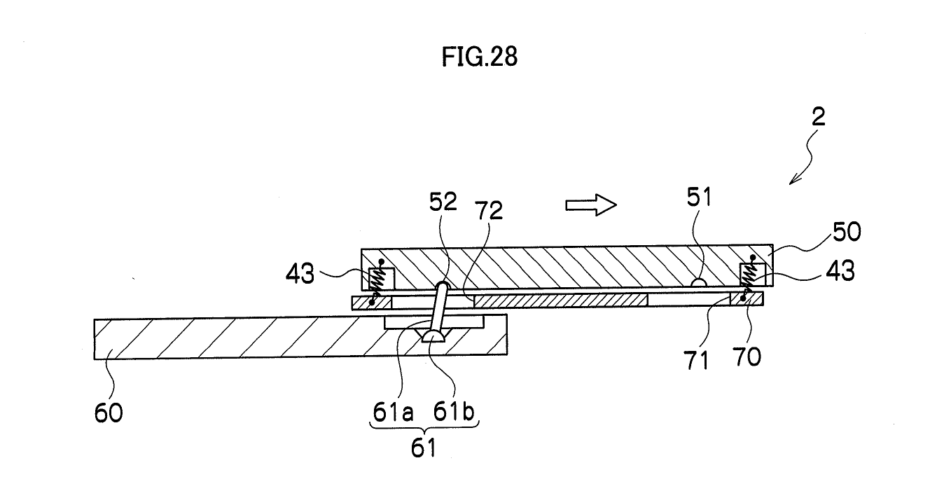

The first enclosure 50 can be manipulated in four directions in the first position and the second position. A method of manipulating the first enclosure 50 will be described below with reference to the second position by way of example. FIG. 28 is a sectional view showing a state in which the first enclosure 50 has been moved upward (direction of an arrow) in the second position.

The substantially spherical part of the tip of the stick 61a, as shown in FIG. 27, is fitted into the recess 52. When an upward external force is applied to the first enclosure 10 in the normal state shown in FIG. 27, simultaneously with the upward shift of the first enclosure 50 relative to the third enclosure 70 until the shifting of the first enclosure 50 is regulated by the regulating device (not shown) as shown in FIG. 28, the stick 61a is inclined upward following the motion of the recess 52. Then, the switch part 61b detects the upward inclination of the stick 61a.

After that, when the upward external force applied to the first enclosure 50 is eliminated, the pressing forces of the springs 43 return the first enclosure 50 to the normal state shown in FIG. 27.

This manipulation is similar in the first position and the second position and in every one of the cross directions.

### [Electrical Configuration of Mobile Telephone 2]

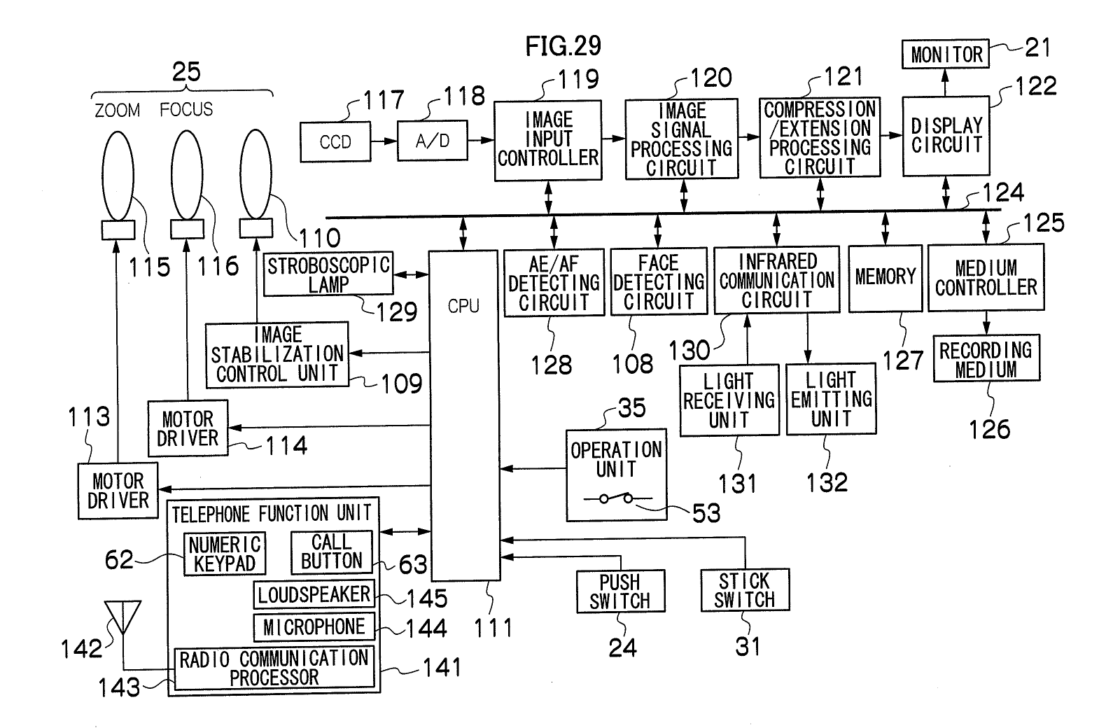

FIG. 29 is a block diagram showing an electrical configuration of the mobile telephone 2 according to the second preferred embodiment of the present invention. The same parts as their counterparts in the block diagram of the digital camera 1 shown in the block diagram of FIG. 9 are assigned respectively the same reference signs, and their description will be omitted. The difference from FIG. 9 is the additional presence of a telephone function unit 141.

The telephone function unit 141 comprises an antenna 142 for transmitting and receiving telephone signals, a radio communication processor 143 for controlling telephone communication, a microphone 144 which is a speech input device, a loudspeaker 145 which is a speech output device and a numeric keypad 146 to enable the user to perform various manipulations.

### [Actions of Mobile Telephone 2]

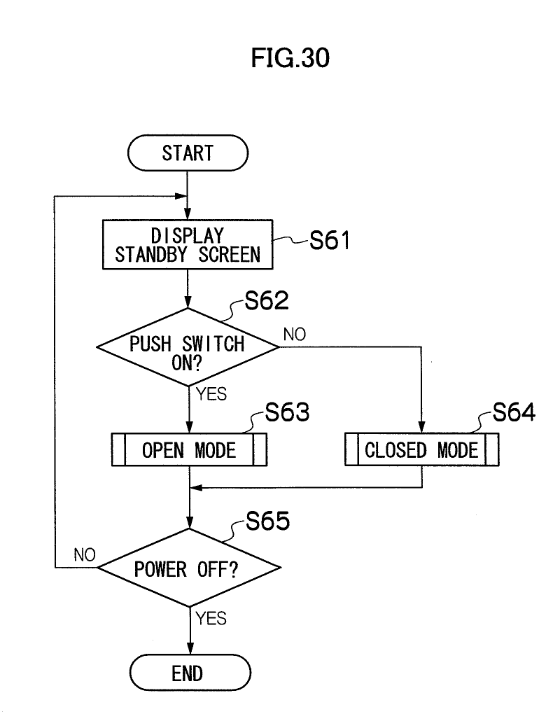

Next, the actions of the mobile telephone 2 will be described with reference to FIG. 30.

When the power supply button 53 is turned on and power is supplied to the mobile telephone 2, a standby screen is displayed on the monitor 21 (step S61). Then, the state of the push switch 24 is determined (step S62). If it is judged that the push switch 24 is on, the CPU 111 sets the mobile telephone 2 in an open mode (step S63). If it is judged that the push switch 24 is off, the CPU 111 sets the mobile telephone 2 in a closed mode (step S64). In this way, the mode is changed over according to the state of the push switch 24.

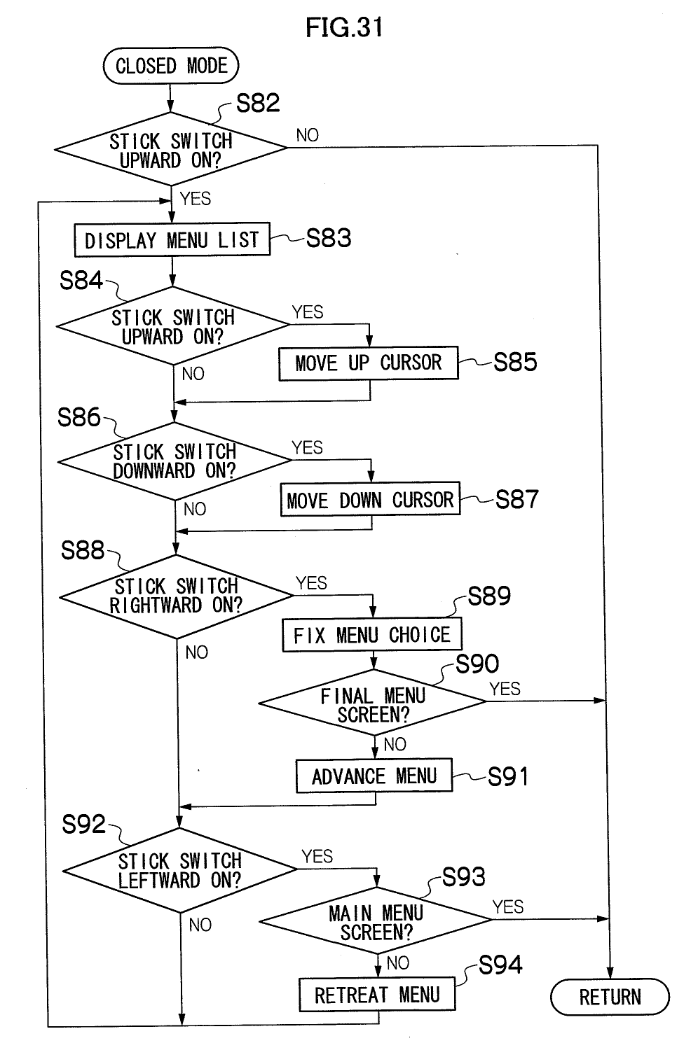

Actions in the closed mode will be described with reference to FIG. 31.

When the user performs manipulation to shift the first enclosure 50 upward in a state in which the standby screen is displayed, the stick switch 61 detects the upward motion of the first enclosure. The CPU 111 displays the main menu on the monitor 21 (step S83) in response to an output signal of the stick switch 61 (step S82). If no upward shifting is done, the subroutine of the closed mode ends, and the processing returns to what is charted in FIG. 30.

In the state in which the menu is displayed, shifting operations in the upward and downward directions correspond to up and down movements of the cursor for menu selection. Thus, when the user manipulates the first enclosure 50 for upward shifting, the CPU 111 moves up the cursor by one step (step S85) in response to an output signal of the stick switch 61 (step S84). Conversely, when the user manipulates the first enclosure 50 downward, the CPU 111 moves down the cursor by one step (step S87) in response to an output signal of the stick switch 61 (step S86).

In the state in which the menu is displayed, a shifting operation in the rightward direction corresponds to fixing (determining) choice of a menu item in the cursor position. Thus, when the user manipulates the first enclosure 50 for rightward shifting, the CPU 111 fixes (determines) the choice of the menu item in the cursor position (step S89) in response to an output signal of the stick switch 61 (step S88). If the screen displayed is the final menu screen of the lowest level (step S90), the subroutine of the closed mode is ended after processing the selected item, and the processing returns to what is charted in FIG. 30. If the screen displayed is not the final menu screen, the level of the menu is lowered by one (step S91).

In the state in which the menu is displayed, a shifting operation in the leftward direction corresponds to a menu retreat. Thus, when the user manipulates the first enclosure 50 leftward, the CPU 111 causes the menu screen to retract to one above (step S94) in response to an output signal of the stick switch 61 (step S92). However, if the screen displayed is the topmost main menu screen (step S93), the subroutine of the closed mode is ended after processing the selected item, and the processing returns to what is charted in FIG. 30. This results in a return from the main menu screen display to the standby screen display.

As described above, processes corresponding to shifting operations in four directions are done in the closed mode.

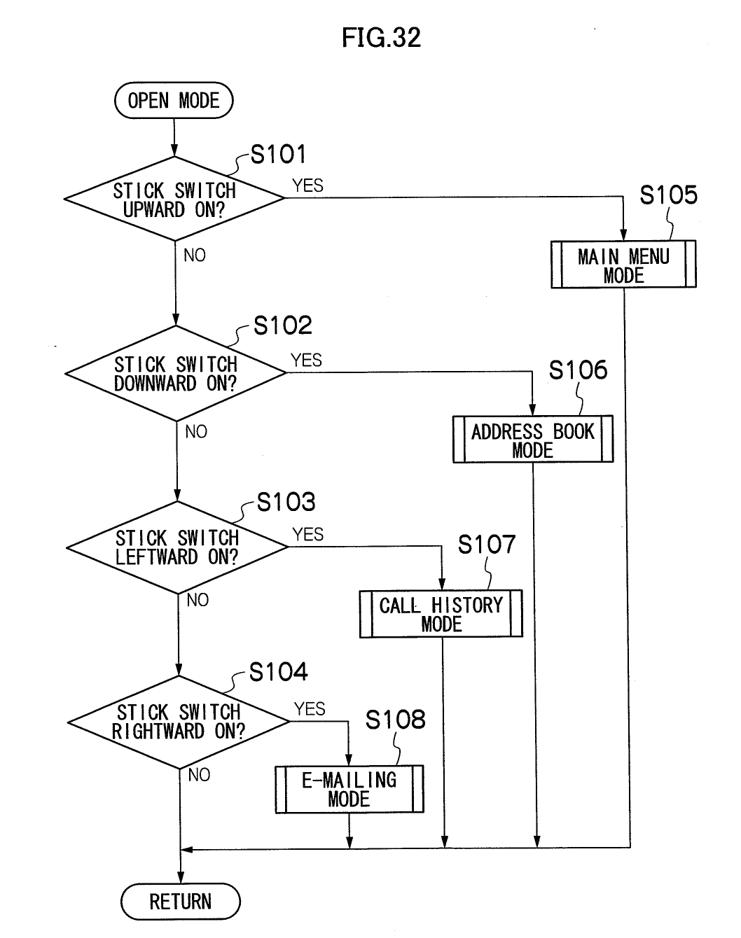

Next, operations (processes) in the open mode will be described with reference to FIG. 32.

In the open mode, shifting operations in different directions correspond to menu choices. When the user manipulates the first enclosure 50 for shifting upward, the CPU 111 causes a change to the main menu mode (step S105) in response to an output signal of the stick switch 61 (step S101). Similarly, manipulations for shifting downward, leftward and rightward (steps S102 through S104), respectively the address book mode, call history mode and e-mailing mode (steps S106 through S108) are selected.

Regarding the main menu mode at step S105, description will be omitted as it involves only similar menu manipulations in the closed mode charted in FIG. 31.

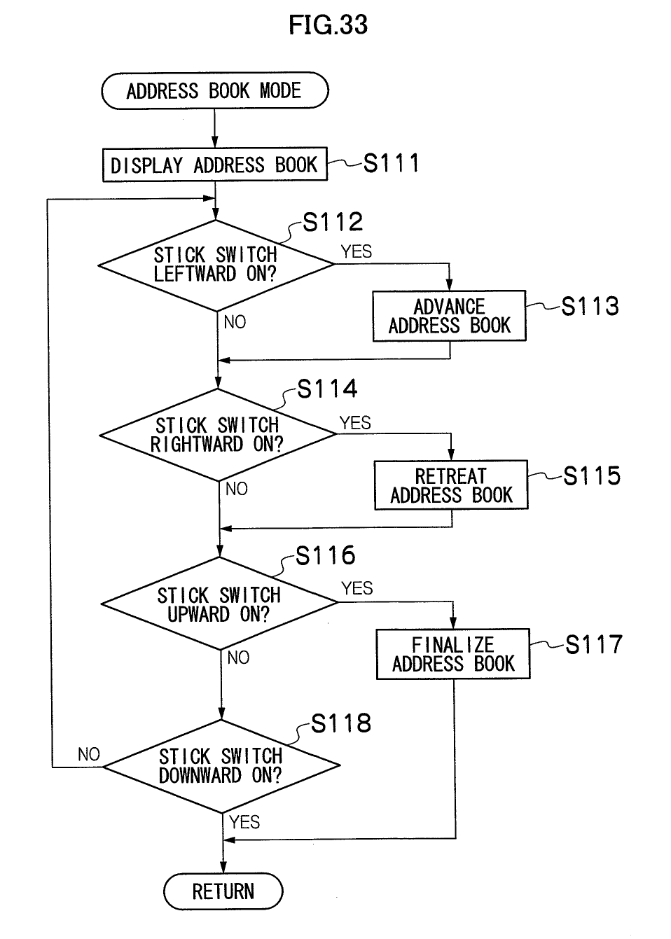

Now, the address book mode will be described with reference to FIG. 33. In this embodiment, the address book is what contains personal names, telephone numbers, e-mail addresses and other data items of any desired number registered in the ascending order in an ROM (not shown) within the CPU 111. These data items can be displayed in a list form on the monitor 21 for one person at a time.

When the mobile telephone 2 is set in the address book mode, data on the first one among the persons whose data are registered in the address book are displayed (step S111).

In this state in which these address book data are displayed, shifting operations in the leftward and rightward directions correspond to person-to-person changes in the address book. Thus, when the user manipulates the first enclosure 50 for shifting leftward, the CPU 11 causes data on the next person in the ascending order to be displayed (step S113) in response to an output signal of the stick switch 61 (step S112). Conversely, when the user manipulates the first enclosure 50 for shifting rightward, the CPU 111 causes data on the person immediately before in the ascending order (step S115) in response to an output signal of the stick switch 61 (step S114).

When the user manipulates the first enclosure 50 for shifting upward (step S116), the CPU 111 processes data on the person then displayed on the screen for initiating a telephone call, transmitting an e-mail and the like (step S117). When the processing ends, the subroutine of the address book mode ends, and the processing returns to what is charted in FIG. 32.

Further, when the user manipulates the first enclosure 50 for shifting downward relative to the third enclosure 70, the CPU 111 ends the subroutine of the address book mode in response to an output signal of the stick switch 61 (step S118), and the processing returns to what is charted in FIG. 32. Thus, it corresponds to manipulation for canceling the address book mode.

In this way, the address book can be worked upon by shift manipulation.

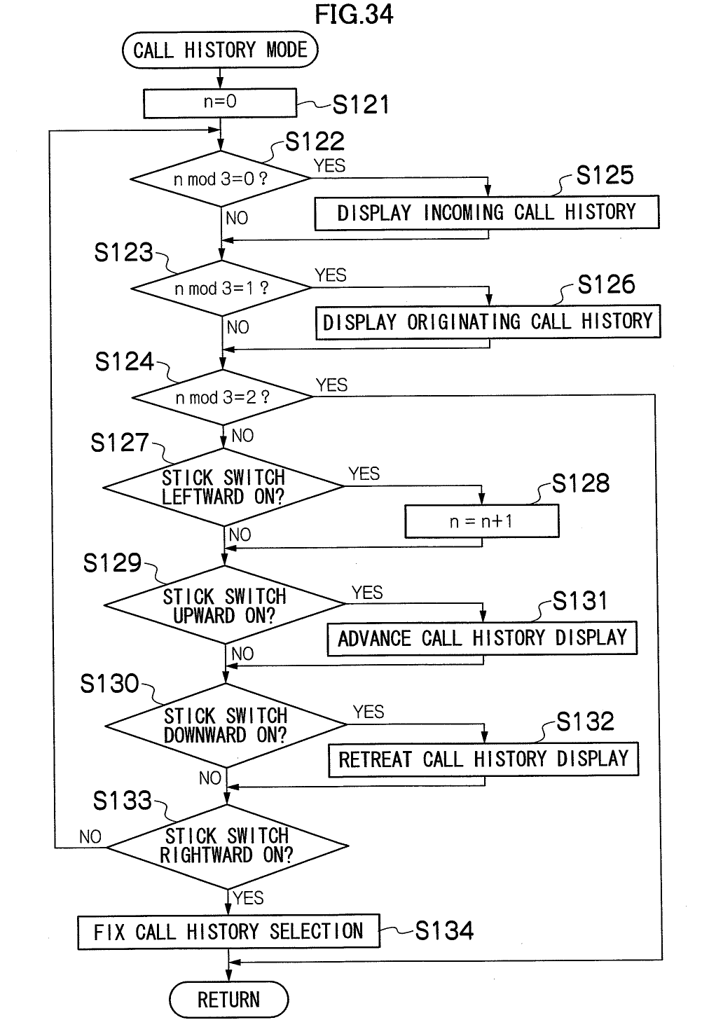

Next, the call history mode will be described with reference to FIG. 34. In the call history mode, incoming call history, originating call history and the standby screen are displayed on the monitor 21 changed over from one to next by repeating leftward shifting operations.

First, a variable n is initialized to 0 (step S121). Next, the remainder of n/3 is calculated (steps S122 through S124), and an action corresponding to the calculated remainder is taken (steps S125 through S126). More specifically, when the remainder is 0, incoming call history is displayed (step S125), or when the remainder is 1, originating call history is displayed (step S126). Or when the remainder is 2, the call history mode is terminated, and the processing returns to what is charted in FIG. 32.

This n value is incremented by leftward shifting operations (steps S127 and S128). As a leftward shifting operation in the open mode means a subroutine shift to the call history mode, every time a leftward shifting operation is done, the display on the monitor 21 is changed over from incoming call history to originating call history and then to the standby screen.

In the state in which incoming call history and originating call history are displayed, upward and downward shifting operations correspond to the up and down movements of the cursor. Thus, when the user manipulates the first enclosure 50 for shifting upward, the CPU 111 moves upward the cursor on the call history listed on the display (step S131) in response to an output signal of the stick switch 61 (step S129). Or, conversely, when the user manipulates the first enclosure 50 for shifting downward (step S130), the CPU 111 moves downward the cursor on the call history listed up on the display (step S132).

Or when rightward shifting is done (step S133), the call history selected by the cursor is subjected to processing such as initiating a telephone call (step S134). When the processing ends, the subroutine of the call history mode ends, and the processing returns to what is charted in FIG. 32.

In this way, call history can be manipulated by shifting operations.

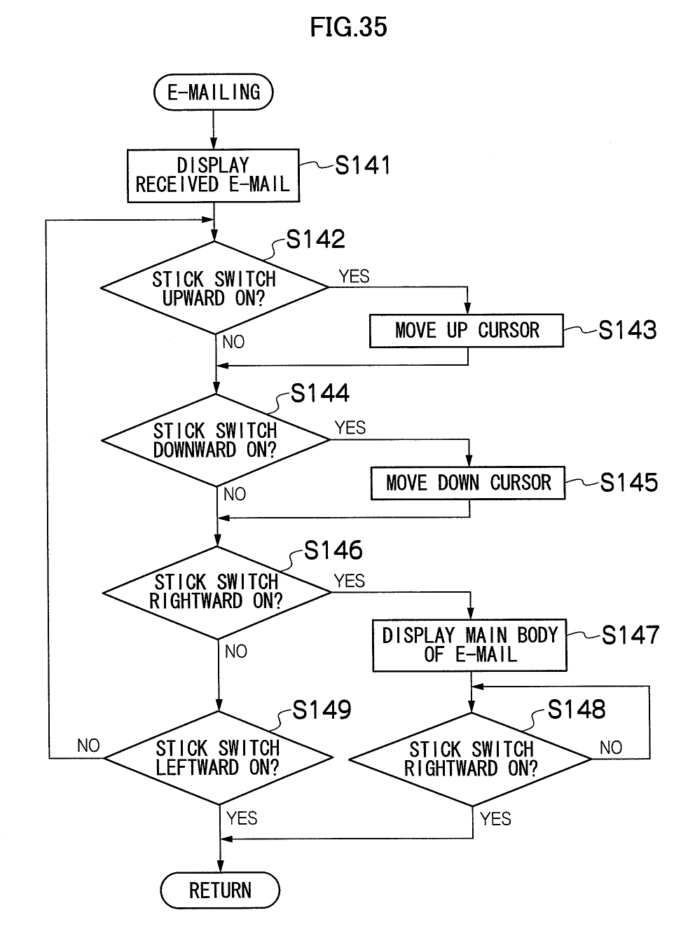

Finally, e-mail manipulations will be described with reference to FIG. 35.

When the mobile telephone 2 is set in the e-mailing mode, the CPU 111 displays on the monitor 21 a list of received e-mails in the order of the days of receipt (step S141).

In the state in which the list of received e-mails is displayed, upward and downward shifting operations correspond to the up and down movements of the cursor to select an e-mail. Thus, when the user manipulates the first enclosure 50 for shifting upward, the CPU 111 moves upward the cursor (step S143) in response to an output signal of the stick switch 61 (step S142). Or, conversely, when the user manipulates the first enclosure 50 for shifting rightward, the CPU 111 moves the cursor downward (step S145) in response to an output signal of the stick switch 61 (step S144).

A rightward shifting operation enables the main body of the e-mail pointed by the cursor to be read. Thus, when the user manipulates the first enclosure 50 for shifting rightward, the CPU 111 displays the main body of the selected received e-mail (step S147) in response to an output signal of the stick switch 61 (step S146). When a rightward shifting operation is performed in the state in which the main body of the e-mail is displayed (step S148), the e-mailing mode ends, and the processing returns to what is charted in FIG. 32. Or, when the user takes a leftward shifting operation in the state in which the list of received e-mails is displayed (step S149), similarly the e-mailing mode ends, and the processing returns to what is charted in FIG. 32.

In this way, e-mailing can be processed by shift manipulations.

Further, when the subroutines of the closed mode at step S63 and of the open mode at step S64 in FIG. 30 are terminated, the position of the power supply button 53 is checked (step S65); if power supply is not off, the processing returns to step S61 and the standby screen is displayed again.

According to the embodiments, since it is possible to respond to various operating modes and manipulations by manipulating the enclosures, an easily operable portable device can be provided.

While this embodiment permits shifting in four directions, the number of directions in which shifting is possible is not limited to four, but the equipment can be designed to allow in different directions. It is also possible to design the enclosures to be capable of swinging each around an axis in addition to shifting.

What is claimed is:

1. A portable device having a first enclosure and a second enclosure, comprising:
a linking device which slidably links the first enclosure and second enclosure in a slidable manner, the linking device permitting a first action of shifting the first enclosure between a first position and a second position in a plane, and a second action of shifting the first enclosure at least in a direction different from a direction of the first action in the plane using at least one of the first position and second position as a reference position; and
a command input device which inputs a command to the portable device on the basis of at least the second action of the first enclosure.

2. The portable device according to claim 1, wherein
the linking device so links the first enclosure and second enclosure as to enable the first enclosure to automatically return to the reference position after the second action.

3. The portable device according to claim 1, wherein
the linking device links the first enclosure and second enclosure so as to be movable, as the second action, in a direction identical to that of the first action.

4. The portable device according to claim 1, wherein
the linking device so links the first enclosure and second enclosure as to enable to move in four, eight or all directions as the second action.

5. The portable device according to claim 1, wherein
the linking device comprises:
a unit which links the first enclosure and the second enclosure in a manner permitting the first action; and
a unit which connects the first enclosure and the second enclosure in a manner permitting the second action.

6. The portable device according to claim 1, wherein
the linking device comprises a unit which halts the first enclosure and the second enclosure in the first position and the second position with a prescribed holding force.

7. The portable device according to claim 1, wherein the linking device so links the first enclosure and second enclosure as to enable to the second action with a force smaller than the holding force.

8. The portable device according to claim 1, further comprising
a second action detecting device which detects a direction of the second action, wherein
the command input device inputs to the portable device a command corresponding to the direction of the second action detected by the second action detecting device.

9. The portable device according to claim 8, further comprising
a first action detecting device which, when the first action has been taken, detects whether the first enclosure is in the first position or the second position, wherein
the command input device differentiates a command corresponding to the direction of the second action between when the first enclosure detected by the first action detecting device is in the first position and that when the first enclosure is in the second position.

10. The portable device according to claim 8, further comprising
a first action detecting device which, when the first action has been taken, detects whether the first enclosure is in the first position or the second position, wherein
the command input device turns on power supply to the portable device when the first detecting device detects that the first enclosure is in the second position.

11. An image pickup device comprising
the portable device according to claim 1, wherein
a shooting lens arranged in front of the second enclosure is covered with the first enclosure when in the first position; and
the shooting lens is exposed when in the second position.

12. The image pickup device according to claim 11, wherein
the first enclosure is a lens barrier.
